(19) United States
(12) Patent Application Publication
(10) Pub. No.: US 2020/0140307 A1
(43) Pub. Date: May 7, 2020

(54) Compact High Throughput Filtering Systems for Wastewater

(71) Applicant: Crane Engineering Sales, Inc., Kimberly, WI (US)

(72) Inventors: Andrew K. Dow, Chicago, IL (US); Jill A. Georger, Appleton, WI (US); Mark J. Hassman, Oshkosh, WI (US); Lewis H. Pain, Fond du Lac, WI (US); Sara Arabi, Wilmette, IL (US)

(73) Assignee: Crane Engineering Sales, Inc., Kimberly, WI (US)

(21) Appl. No.: 16/399,714

(22) Filed: Apr. 30, 2019

Related U.S. Application Data
(60) Provisional application No. 62/754,218, filed on Nov. 1, 2018.
(60) Provisional application No. 62/794,878, filed on Jan. 21, 2019.

(51) Int. Cl. C02F 9/00; B01D 61/02; B01D 61/08; B01D 61/12; B01D 61/14; B01D 61/18; B01D 61/22; B01D 61/58; B01D 61/04; B01D 61/16

(52) U.S. Cl. CPC C02F 9/00; B01D 61/025; B01D 61/08; B01D 61/12; B01D 61/147; C02F 1/004; B01D 61/22; B01D 61/58; B01D 61/04; B01D 61/16; B01D 61/18

(57) ABSTRACT

Filtering systems can process wastewater to provide a primary output of clear water and a secondary output of sludge. The filtering systems are compact, optionally mobile and optionally truck-mountable, and have a high throughput capacity and cleaning effectiveness. For a system having a volume VS, and for wastewater having a TSS content of TSS1 and a COD of COD1, the primary output may have a TSS<1% of TSS1, a COD<2% of COD1, and a turbidity of <1, or 0.5, or 0.3 NTU. The system may receive the wastewater at a flow rate F1 and provide the primary output while receiving the wastewater, and F1/VS may be ≥0.2 hr⁻¹. F1 may be ≥1 L/sec, and VS may be ≥5 m³, or ≤30 m³, or in a range from 20-30 m³. The primary output may have a flow rate ≥40%, or 50%, or 60% of F1.

### CROSS-REFERENCE TO RELATED APPLICATIONS

This application claims priority under 35 U.S.C. § 119 (e) to provisional patent application U.S. Ser. No. 62/754,218, “Compact High Throughput Filtering System for Wastewater”, filed Nov. 1, 2018, and provisional patent application U.S. Ser. No. 62/794,878, “More Compact High Throughput Filtering Systems for Wastewater”, filed Jan. 21, 2019, the contents of which are incorporated herein by reference.

### FIELD OF THE INVENTION

The present invention relates to water treatment systems for cleaning or otherwise processing biowaste, septage, sewage, and other wastewater, with particular focus on such systems that use separation technologies such as filtering technologies to accomplish the treatment. The invention also pertains to related methods, systems, and articles.

### BACKGROUND OF THE INVENTION

Wastewater treatment systems serve a critical role in maintaining the health, cleanliness, and beauty of cities, towns, and other communities by processing the human waste generated by residents of such communities, converting such waste into stabilized sludge and purified water that can be safely discharged to the environment. Wastewater treatment systems have also been tailored for use with animal populations, as on farms, and for other water purification applications such as desalination of seawater.

Numerous such wastewater treatment systems have been built and operated with great success over the years. These systems exhibit significant diversity in terms of design factors such as system capacity, effluent quality level (purity), size, automation, technologies employed, and maintenance required.

Early wastewater treatment systems included a tank which was used for both treatment of the wastewater and solids removal, typically by settling. These systems did not include aeration, and produced foul odors.

Later systems used a technique referred to as “activated sludge”. In these systems, an aeration tank is followed by a solids/liquid separator. The aeration tank combines incoming wastewater with activated sludge (microorganism rich residue) from the solids/liquid separator. These contents arc mixed with mechanical mixers and aerated in the tank to produce an aerobic reaction involving absorption, adsorption, and biological digestion. Following a reaction period, after which contaminants are completely digested, the mixture flows from the aeration tank to the solids/liquid separator, and some sludge from the separator is returned to the aeration tank.

More recently, membrane bioreactors (MBRs) have been used in wastewater treatment to combine biological treatment with a membrane separation step. In that regard, MBR systems separate and concentrate biomass from water using membranes rather than the prior settling techniques. MBR systems can use membranes of any type or porosity, including reverse osmosis (RO), nanofiltration (NF), ultrafiltration (UF), microfiltration (MF), and other known solids/liquid separation membranes. In one type of MBR system, the membrane(s) are mounted directly in the aeration tank. This is referred to as a submerged MBR system. In another type of MBR system, the membrane(s) are external to the aeration tank, downstream from the bioreactor, This is referred to as an external MBR system.

In U.S. Pat. No. 7,648,634 (Probst), a system and method of treating wastewater is described including a treatment container for receiving and treating wastewater and a mixing/aeration system disposed in the treatment container. Wastewater is pumped under pressure from the treatment container through a solids/liquid separation system, preferably comprising multiple parallel membrane bioreactors, to separate the solids and liquids in the wastewater. Liquid retentate from the solids/liquid separation system is cycled hack to the treatment container via the mixing/aeration system. The closed-loop system and method for solids/liquid separation and aeration/mixing is said to provide for reduced equipment requirements and energy usage during operation.

### SUMMARY OF THE INVENTION

A need exists in the industry for alternative systems and methods for purifying biowaste, septage, sewage, and other wastewater.

We have developed a new family of wastewater treatment systems and methods. Tee systems and methods are capable of providing high throughput capacity and high treatment/cleaning/filtering effectiveness in a compact space or package, some embodiments of which can optionally be adapted for mounting on a truck or other moving vehicle, or can otherwise be mobile. “High throughput capacity” in this regard refers to systems in which the volume of the clean, processed output fluid is a substantial fraction, e.g., at least roughly half, of the volume of the input wastewater, and/or the system flux—as measured by the input flow rate divided by the physical system volume, discussed further below—is high. In exemplary embodiments, the systems and methods utilize separation technologies such as filtering technologies primarily or exclusively to process or treat the wastewater. For simplicity, at least some embodiments of the system preferably avoid or omit one, some, or all of aeration tanks, settling tanks, reaction tanks, off-line buffer tanks, chemical reactions, chemical coagulants, chemical additives, biological processes, electro-coagulation, oxidizing agents, combustion, electrolysis, sacrificial electrodes, and the like.

In some cases, the system may be suitable for converting wastewater to a primary output of clear water and a secondary output of concentrated sludge, and may occupy a rectilinear space of volume VS, and may be configured such that, for wastewater having a total suspended solids (TSS) content of TSS1 (such as 200 or 500 mg/L) and a chemical oxygen demand (COD) of COD1 (such as 2,500 or 3,000 mg/L): the system receives the wastewater at a flow rate F1 and provides the primary output at least in part while receiving the wastewater; the primary output has a flow rate F2, where F2 is at least 40% of F1; the primary output has a TSS of less than 1% of TSS1 (e.g. 2 mg/L), a COD of less than 2% of COD1 (e.g. 50 mg/L), and a turbidity of less than 1 NTU; and F1/VS is at least 0.2 hr⁻¹.

We also disclose systems suitable for converting wastewater to a primary output of clear water and a secondary output of concentrated sludge, the system occupying a rectilinear space of volume VS, wherein the system is configured such that, for wastewater having a total suspended solids (TSS) content of TSS1 (such as 200 or 500 mg/L) and a chemical oxygen demand (COD) of COD1 (such as 2,500 or 3,000 mg/L); the system receives the wastewater at a flow rate F1 and provides the primary output at least in part while receiving the wastewater; the primary output has a flow rate F2, where F2 is at least 40% of F1; the primary output has TSS of less than 1% of TSS1 (e.g. 2 mg/L), a COD of less than 2% of COD1 (e.g. 50 mg/L), and a turbidity of less than 1 NTU; VS is at least 5 m³; and F1/VS is at least 0.2 hr⁻¹.

The ratio F1/VS may be at least 0.3 hr⁻¹, or at least 0.5 hr⁻¹0 , or in a range from 0.2-0.6 hr⁻¹, or in a range from 0.3-0.6 hr⁻¹. F1 may be at least 2 L/sec, or at least 3 L/sec, or in a range from 1-4 L/sec, or in a range from 2-4 L/sec. F2 may be at least 50% of F1, or at least 60% of F1. VS may be at least 5, or at least 10, or at least 20 m³, or no more than 50, or 40, or 30 m³, or in a range from 20-50 or 20-30 m³.

The primary output may have a TSS content no more than 0.4% of TSS1. The primary output may have a turbidity less than 0.5 NTU, or less than 0.3 NM.

The system may also include: a debris management (DM) section having an input, a filtered output, and a concentrated output; a microfiltration (MF) section having an input, a filtered output, and a concentrated output; and a reverse osmosis (RO) section having an input, a filtered output, and a concentrated output; and the input of the MF section may couple to the filtered output of the DM section, and the input of the RO section may couple to the filtered output of the MF section; and the primary output may be the filtered output of the RO section. The system may also include: an intermediate tank coupled to receive the filtered output of the MF section; and a valve configured to selectively couple contents of the intermediate tank to the input of the MF section.

The system may also include a receiving tank coupled to the DM input, and the receiving tank may have a capacity C1 and the intermediate tank may have a capacity C2, and the system may include no tank whose capacity is greater than the greater of C1 and C2. The system may omit at least one of, or all of, the following: an aeration tank, a settling tank, a reaction tank, and an off-line butler tank. The system may omit at least one of, or all of, the following: chemical reactions, chemical coagulants, chemical additives, biological processes, electro-coagulation, oxidizing agents, combustion, electrolysis, and sacrificial electrodes. The system may have an Energy Consumed per Volume Processed (ECVP) value of no more than 30, or 20, or 10 kW*hr/m³, or in a range from 1-30, or 1-20, or 2-10 kW*hr/m³.

We also disclose filtering systems suitable for converting wastewater to a primary output of clear water and a secondary output of concentrated sludge, such a system including: a debris management (DM) section having a DM input, a DM filtered output, and a DM concentrated output; a first filtration section having. a first input, a first filtered output, and a first concentrated output; and a second filtration section having a second input, a second filtered output, and a second concentrated output; wherein the first input couples to the DM filtered output, and the second input couples to the first filtered output; and wherein the primary output is the second filtered output. The first and second filtration sections may both include membrane filtration elements. The first and second filtration sections may both include cross-flow membrane filtration elements. The first filtration section may include a microfiltration (MF) element, and the second filtration section may include a reverse osmosis (RO) element.

The system may also include an intermediate tank coupled to receive the first filtered output, and a valve configured to selectively couple contents of the intermediate tank to the first input. The system may also include a receiving tank coupled to the DM input, and the receiving tank may have a capacity C1 and the intermediate tank may have a capacity C2, and the system may include no tank whose capacity is greater than the greater of C1 and C2. The system may occupy a rectilinear space of volume VS, and may be configured such that, for wastewater having a total suspended solids (TSS) content of TSS1 (such as 200 or 500 mg/L) and a chemical oxygen demand (COD) of COD1 (such as 2,500 or 3,000 mg/L): the system receives the wastewater at a flow rate F1 and provides the primary output: at least in part while receiving the wastewater; the primary output has a flow rate F2, where F2 is at least 40% of F1; the primary output has a TSS of less than 1% of TSS1 (e.g. 2 mg/L), a COD of less than 2% of COD1 (e.g. 50 mg/L), and a turbidity of less than 1 NTU; and F1/VS is at least 0.2 hr⁻¹. F1/VS may be at least 0.3 hr⁻¹, or at least 0.5 hr⁻, or in a range from 0.2-0.6 hr⁻¹, or in a range from 0.3-0.6 hr⁻¹. VS may be at least 5, or at least 10, or at least 20 m³, or no more than 50, or 40, or 30 m³, or in a range from 20-50 or 20-30 m³. The system may have an Energy Consumed per Volume. Processed (ECVP) value of no more than 30, or 20, or 10 kW*hr/m³, or in a range from 1-30, or 1-20, or 2-10 kW*hr/m. The system may omit an aeration tank, a settling tank, a reaction tank, and an off-line buffer tank. The system may omit chemical reactions, chemical coagulants, chemical additives, biological processes, electro-coagulation, oxidizing agents, combustion, electrolysis, and sacrificial electrodes.

We also disclose filtering systems suitable for converting wastewater to a primary output of clear water and a secondary output of concentrated sludge, such a system including; a debris management (DM) section having a DM input, a DM filtered output, and a DM concentrated output; a first filtration section having. a first input, a first filtered output, and a first concentrated output; a second filtration section having a second input, a second filtered output, and a second concentrated output; an intermediate tank; and an electronic control system configured to control fluid flow through the DM module, the first filtration module, and the second filtration module; wherein the electronic control system is configured to operate the system in a first mode wherein the DM filtered output from the DM section is received by the MF section, and the first filtered output from the MF section is received by the intermediate tank, and contents of the intermediate tank are directed to the RO section; and wherein the electronic control system is configured to operate the system in a second mode wherein the DM section and the RO section arc fluidly isolated from the MF section, and the contents of the intermediate tank are received by the MF section, and the first filtered output from the MF section is received by the intermediate tank,

The system may occupy a rectilinear space of volume VS, and may be configured such that, for wastewater having a total suspended solids (TSS) content of TSS1 (such as 200 or 500 mg/L) and a chemical oxygen demand (COD) of COD1 (such as 2,500 or 3,000 mg/L): the system receives the wastewater at a flow rate F1 and provides the primary output at least in part while receiving the wastewater; the primary output has a flow rate F2, where F2 is at least 40% of F1; the primary output has a TSS of less than 1% of TSS1 (e.g. 2 mg/L), a COD of less than 2% of COD1 (e.g. 50 mg/L), and a turbidity of less than 1 NTU; and F1/VS is at least 0.2 hr⁻¹, F1/VS may be at least 0.3 hr⁻¹, or at least 0.5 hr⁻¹, or in a range from 0.2-0.6 hr⁻¹, or in a range from 0.3-0.6 hr⁻¹. The system may omit an aeration tank, a settling tank, a reaction tank, and an off-line buffer tank. The system may omit chemical reactions, chemical coagulants, chemical additives, biological processes, electro-coagulation, oxidizing agents, combustion, electrolysis, and sacrificial electrodes.

We also disclose numerous methods relating to the filtering or separation of clear water from incoming wastewater or septage. For example, in a filtering system that includes a debris management (DM) section, a microfiltration (MF) section, a reverse osmosis (RO) section, and an intermediate tank, we disclose a method that includes: operating the system in a first mode wherein a DM filtered output from the DM section is received by the MF section, and a first filtered output from the MF section is received by the intermediate tank, and contents of the intermediate tank are directed to the RO section; and operating the system in a second mode wherein the DM section and the RO section are fluidly isolated from the MF section, and the contents of the intermediate tank are received by the MF section, and the first filtered output from the MF section is received by the intermediate tank.

Numerous related methods, systems, and articles are also disclosed.

These and other aspects of the present disclosure will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

The inventive articles, systems, and methods are described in further detail with reference to the accompanying drawings, of which:

FIG. 1 is a schematic diagram showing the high level function of at least some of the disclosed systems;

FIG. 2 is a perspective view of a rectilinear space within which a fully assembled disclosed system may fit;

FIG. 3 is a schematic side view of a conventional truck on which is mounted a compact filtering system, represented schematically by the rectilinear space of FIG. 2;

FIG. 4 is a schematic view of a possible service route for the mobile truck-mounted filtering system of FIG. 3;

FIG. 5 is a graph of process flow versus system size;

FIG. 6 is a simplified diagram showing major subsystems of a disclosed filtering system, and their respective arrangement and functions;

FIG. 7 is a schematic perspective view of a cross-flow microfiltration (MF) device;

FIG. 8 is a schematic plan view of an MF device in a serpentine or coiled arrangement;

FIG. 9 is a schematic perspective view of a cross-flow reverse osmosis (RO) device, with a portion cut away to reveal interior components;

FIG. 10 is a more detailed schematic system diagram of a filtering system suitable for cleaning wastewater and the like;

FIG. 11 is a high-level flow diagram of an on-board system flush mode of operation;

FIG. 12 is a collection of idealized waveforms representing the function or status of various elements of a filtering system as a function of time;

FIGS. 13A-13D are test results on an MF unit suitable for use in the disclosed systems;

FIGS. 14 and 15 are different perspective views of a filtering system substantially similar to one that was constructed and tested;

FIG. 16 is a front elevation view of the filtering system of FIGS. 14 and 15;

FIG. 17 is a top plan view of the filtering system of FIGS. 14-16;

FIGS. 18 and 19 are side elevation views of opposite sides of the filtering system of FIGS. 14-17; and

FIG. 20 is a photograph of several glass jars of material processed by a filtering system that was constructed substantially in accordance with FIGS. 14-19, where one jar holds septage that was used as input material and the other jars hold output materials from the system.

In the figures, like reference numerals designate like elements.

### DETAILED DESCRIPTION OF ILLUSTRATIVE EMBODIMENTS

We have developed a new family of wastewater treatment systems and methods. At least some embodiments utilize, comprise, or consist essentially of filtering systems that are capable of providing high throughput capacity, and high treatment/cleaning/filtering effectiveness, in a compact space or package. At least some embodiments preferably avoid or omit one, some, or all of the following: aeration tanks, settling tanks, reaction tanks, off-line buffer tanks (or any type of large buffer tank, discussed below), chemical reactions, chemical coagulants, chemical additives, biological processes, electro-coagulation, oxidizing agents, combustion, electrolysis, sacrificial electrodes, and the, like. If desired, the systems can be adapted for mounting on or in conventional land, water, or air vehicles, including for example a conventional truck, or can otherwise be mobile.

In that regard, at least some of the disclosed systems may be characterized as being especially suited for use in medium-capacity applications, as distinguished from large-capacity applications such as a typical municipal wastewater treatment plant, and as distinguished from small-capacity applications such as handheld filtration devices designed for personal use. Medium-capacity wastewater treatment systems may be characterized by the flow rate F1 at which the system receives the wastewater to be treated, where F1 is typically at least 1, or 2, or 3 L/sec, but typically no more than 10, or 8, or 6, or 4 L/sec, or in a range from 1-4 or 2-4 L/sec. Alternatively or additionally, medium-capacity wastewater treatment systems may be characterized in terms of their physical size, e.g., having a system volume VS of typically at least 5, or 10, or 20 m³, but typically no more titan 50, or 40, or 30 m³, or in a range from 20-50 m³, or from 20-30 m³. However, the disclosed systems are also capable of being scaled up in size (with a corresponding increase in capacity or throughput) beyond these limits.

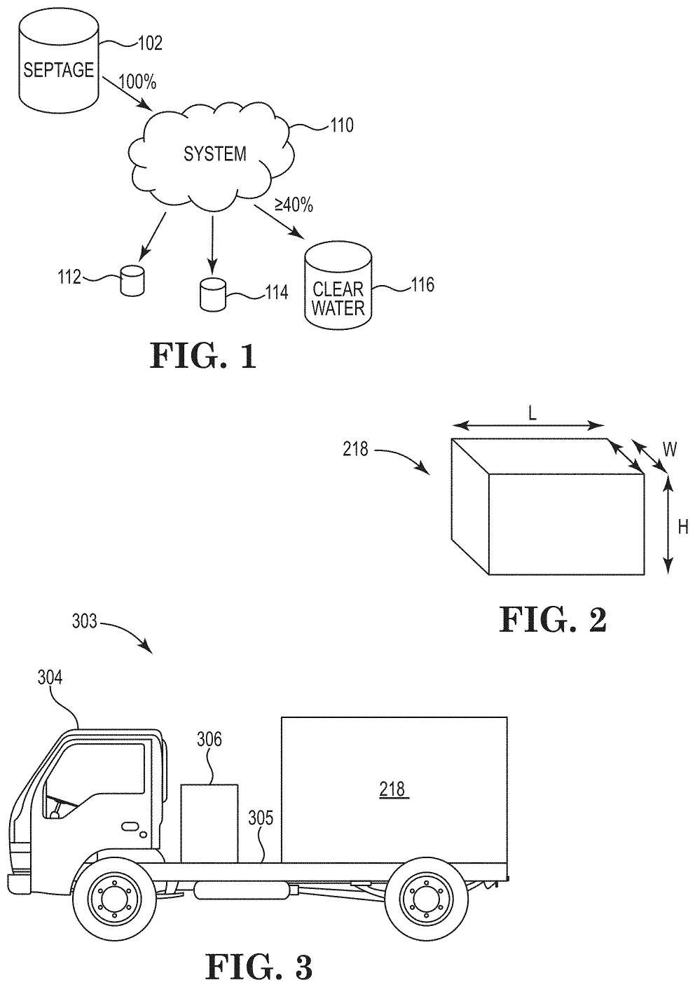

A schematic diagram showing the high level function of at least some of the disclosed treatment or filtering systems is shown in FIG. 1. In that figure, the system 110 receives septage, sewage, human or animal waste, biowaste or other wastewater 102 as input material to be processed. The function of the system 110 is then to remove all, or substantially all, solids and bacteria. The system 110 may in some cases process human fecal sludge into non-potable water fear agricultural or industrial use. The system 110 separates e.g. by multiple filtering stages the septage 102 into distinct outputs: debris 112, sludge 114, and clear water 116. The composition, content, and relative proportions of the debris, sludge, and clear water will depend on the nature and characteristics of the septage 102.

Typically, the debris 112 may be or comprise light debris that may be present in the incoming wastewater 102, i.e., debris that substantially floats or is suspended in the slurry (septage), or heavy debris, i.e., debris that substantially sinks in the slurry, or both light and heavy debris. Examples of light debris include certain trash, hair, wood, plastic items, paper items, diaper products, and menstrual products. Examples of heavy debris include certain trash, rocks, sand, grit, metal items, and glass items.

Sludge 114 may typically be or comprise a thick slurry containing a range of small to microscopic to sub-microscopic particles, including one or. ore of dissolved solids, suspended solids, oils, fats, bacteria, pathogens, and the like. The particles that make up the sludge 114 may have characteristic sizes or diameters ranging from a few millimeters to a nanometer or less. The sludge 114 is a flowable liquid but more concentrated than the input wastewater 102.

The clear water 116 output by the system 110 preferably has a visually clean, clear appearance. The clear water 116 is preferably pathogen free or substantially pathogen free, and preferably meets all, or most, or at least some of the conditions set forth in Table 1 below, even when the input material is septage 102 having a TSS of 200 or 500 mg/L and a COD of 2,500 or 3,000 mg/L. In the table, TSS refers to total suspended solids, TDS refers to total dissolved solids, COD refers to chemical oxygen demand, BOD refers to biochemical oxygen demand, sCOD refers to soluble COD, sBOD refers to soluble BOD, TKN refers to Total Kjeldahl Nitrogen, and turbidity is measured in nephelometric turbidity units (NTU):

TABLE 1
Treatment Capability (Minimal)

| | | value for input | maximum value for output | % | comple- |
|---|---|---|---|---|---|
| Parameter | Units | material (septage 102) | material (clear water 116) | reduction | ment (%) |
| TSS | mg/L | 200 | 20, more preferably 2 | ≥99 | <1 |
| TDS | mg/L | | 400 | | |
| COD | mg/L | 2,500 | 50 | ≥98 | <2 |
| BOD | mg/L | | 50 | | |
| sCOD | mg/L | | 50 | | |
| sBOD | mg/L | | 50 | | |
| TKN | mg/L | | 10 | | |
| Total phosphorus | mg/L | | 0.05 | | |
| e. coli | MPN/100 ml | | 1,000 | | |
| Turbidity | NTU | | 10, more preferably 1 | | |
| helminth ova | per liter | | 1 | | |
| ascaris | | | | | |
| pH | | | (in range from 5.0 to 9.0) | n/a | |
| Temperature | deg C. | | 60 | n/a | |

Table 2 below provides a more detailed specification of a relatively low difficulty treatment/cleaning/filtering capability that most or man embodiments of the disclosed filtering systems 110 can achieve, for a particular septage 102 input material.

TABLE 2
Treatment Capability (Low Difficulty)

| | | value for input | maximum value for output | % | comple- |
|---|---|---|---|---|---|
| parameter | Units | material (septage 102) | material (clear water 116) | reduction | ment (%) |
| TSS | mg/L | 500 | 2 | ≥99.6 | <0.4 |
| TDS | mg/L | 1,000 | 400 | ≥60 | <40 |
| COD | mg/L | 3,000 | 50 | ≥98.3 | <1.7 |
| BOD | mg/L | 700 | 50 | ≥92.9 | <7.1 |
| sCOD | mg/L | 300 | 50 | ≥83.3 | <16.7 |
| sBOD | mg/L | 200 | 50 | ≥75 | <25 |
| TKN | mg/L | 200 | 10 | ≥95 | <5 |
| Total phosphorus | mg/L | 20 | 0.05 | ≥99.8 | <0.2 |
| e. coli | MPN/100 ml | 1,000 | 100 | ≥90 | <10 |
| turbidity | NTU | | 0.3 | | |

COD is the most comprehensive measure of total oxygen demand of the organics or reduced species in the wastewater that could deplete oxygen levels in a receiving body of water and thereby harm aquatic life. It is also an indicator of the amount of carbon available to support biological growth. TSS is tied to COD (particulate components exerting oxygen demand) and, along with turbidity, is a measure of water clarity and aesthetic quality as well as relative microbial risk or loading (i.e., microbes or solids containing bound microbes).

Table 3 below provides a detailed specification of a moderate difficulty treatment/cleaning/filtering capability that many embodiments of the disclosed filtering systems 110 can achieve, tor a particular septage 102 input material.

TABLE 3
Treatment Capability (Moderate Difficulty)

| | | value for input | maximum value for output | % | comple- |
|---|---|---|---|---|---|
| parameter | Units | material (septage 102) | material (clear water 116) | reduction | ment (%) |
| TSS | mg/L | 5,000 | 2 | ≥99.96 | <0.04 |
| TDS | mg/L | 1,500 | 200 | ≥86.7 | <13.3 |
| COD | mg/L | 15,000 | 50 | ≥99.7 | <0.3 |
| BOD | mg/L | 3,000 | 50 | ≥98.3 | <1.7 |
| sCOD | mg L | 2,500 | 50 | ≥98 | <2 |
| sBOD | mg/L | 2,000 | 50 | ≥97.5 | <2.5 |
| TKN | mg/L | 400 | 5 | ≥98.8 | <1.2 |
| Total phosphorus | mg/L | 20 | 0.05 | ≥99.8 | <0.2 |
| e. coli | MPN/100 ml | 1,000 | 10 | ≥99 | <1 |
| turbidity | NTU | | 0.3 | | |

BOD is another common unit for measuring oxygen demand and represents what is more biologically available or likely to get oxidized in receiving waters (depleting oxygen) or support biological activity. Soluble COD and BOD are important qualifiers that can dictate the overall effluent (output) COD and BOD and the overall COD and BOD removal. Specifying E. Coli would further define microbial water quality.

Table 4 below provides a detailed specification of a higher difficulty treatment/cleaning/filtering capability that at least some embodiments of the disclosed filtering systems 110 can achieve, for a particular septage 102 input material.

TABLE 4
Treatment Capability (Higher Difficulty)

| | | value for input | maximum value for output | % | comple- |
|---|---|---|---|---|---|
| parameter | Units | material (septage 102) | material (clear water 116) | reduction | ment (%) |
| TSS | mg/L | 20,000 | 2 | ≥99.99 | <0.01 |
| TDS | mg/L | 2,500 | 100 | ≥96 | <4 |
| COD | mg/L | 60,000 | 50 | ≥99.9 | <0.1 |
| BOD | mg/L | 12,000 | 50 | ≥99.6 | <0.4 |
| sCOD | mg/L | 2,500 | 50 | ≥98 | <2 |
| sBOD | mg/L | 2,000 | 50 | ≥97.5 | <2.5 |
| TKN | mg/L | 400 | 5 | ≥98.8 | <1.2 |
| Total phosphorus | mg/L | 20 | 0.02 | ≥99.9 | <0.1 |
| e. coli | MPN/100 ml | 1,000 | 1 | ≥99.9 | <0.1 |
| turbidity | NTU | | 0.3 | | |

TDS is a parameter that further describes water purity and aesthetic (taste) quality with some health implications. The US EPA secondary standard for drinking water is 500 mg/L. Nutrients (TKN and total phosphorus) can be important treated water quality parameters because they can support microbiological activity mid can lead to harmful indirect oxygen depletion and related environmental impacts in receiving waters (e.g. accelerated eutrophication, algae blooms).

In at least some embodiments of the system 110, the clear water 116 may not be potable, i.e., may not be safe for human consumption, however, if it meets the conditions of at least Table 1 above, the clear water is considered safe for local discharge to the ground under current health guidelines. The clear water 116 may for example be discharged on-site or of locally in a field, stream, ditch, or it can, if desired, be collected and hauled away for other uses, such as irrigation. Some embodiments of the system 110 may include additional filtering or processing stage(s) such that the clear water 116 extracted by the system 110 is safe for human consumption (potable).

The composition of septage varies widely from place to place throughout the world according to local sanitation practices, available sanitary infrastructure, climate, rainfall, water availability, and other factors. One key measure of septage is total solids content (TS), defined as the mass fraction cant given input material that is solid, and equal to the sum of TSS and TDS. According to generally accepted global data, the TS value for human septage ranges from 0.02% to 16.8%, with a median value of 0.38%. Such a wide range of total solids can hate a substantial effect on the performance of the system 110. For example, when processing septa 102 having a high TS, the system 110 can be expected to produce a relatively smaller amount of clear water 116 than for septage 102 having a lower TS. Preferably, the system 110 is designed such that the volume V2 of clear water 116 extracted from a volume V1 of septage 102 is at least 40% or at least 50%, or at least 60%, or in a range from 40-80%, or 50-80%, or 60-80% of the volume V1, at least for septage whose TS is no more than 1%.

The specifications given in each of Tables 1 through 4 above can be considered in whole or in part as desired. For example, a filtering system may be capable of satisfying all the conditions laid out in Table 3 (or any of the other tables) simultaneously, as where the input septage or wastewater has a TSS, TDS, COD, BOD, sCOD, sCOD, TKN, Total phosphorus, E. coli, and turbidity as specified in the table, and where the output material derived from such an input has respective values for all such properties that. are no greater than those listed in the column for the output material. A filtering system may alternatively—or also—be capable of satisfying one, some, or all of the conditions laid out in Table 3 (or any of the other tables) individually, as where the system can process a first input sample of input wastewater whose TSS is 5,000 mg/L (but whose other properties may not satisfy some or all of the other conditions in Table 3 for the input material), and can convert such a sample to a first output TSS sample of clear water whose TSS is no more than 2 mg/L, but whose other properties may not satisfy some or all of the other conditions in Table 3 for the output material. Furthermore, the column for “% reduction” (and its mathematical complement) in Tables 1 through 4 may be interpreted as applying not only in cases where values for the input material and values for the output material satisfy the values in their respective columns, but also in cases where, for example, the input material has a value for the respective property that is higher or lower than that specified in the column for the input material.

In that regard, unless otherwise noted, the term wastewater as used herein preferably refers to septage sewage, biowaste, or other forms of wastewater for which the TSS is at least 100, or 200, or 300 mg/L, and for which the COD is at least 100, or 250, or 500 mg/L, and for which the turbidity is at least 200, or 250, or 300, or 400, or 500 NTU.

Besides the ability of the system 110 to extract a relatively large amount of clear water from the incoming septage and separate out undesirable solids and bacteria, we also consider it desirable for the system to be relatively compact, or small in size. “Compact” and “small” are relative terms, hence, for better precision we may say the system size is small in relation to a conventional wastewater treatment system having comparable performance characteristics. The size of the system 110 may be in reference to its volume, measured in units of volume such as cubic meters (m³) or liters (L), or to its footprint size, measured in units of area such as square meters (m²), or to both its volume and footprint size. These concepts are best defined not with regard to volumes or footprints of arbitrary shapes, but with regard to useful, practical rectilinear shapes. For purposes of this document, a 2-dimensional rectilinear shape is a rectangle (which we interpret as including a square), and a 3-dimensional rectilinear shape is a volume bounded by six rectangular sides (including in some cases square sides), with opposite sides being parallel and adjacent sides being perpendicular.

An exemplary rectilinear-shaped volume or space 218 is shown in FIG. 2. The volume 218 is characterized by mutually perpendicular dimensions of length L, width W, and height H. The space 218 can be said to be characteristic or representative of a given system HO if the space is the smallest “box” into which the system 110 (in its fully assembled form, but not counting any external connecting hoses, wires, conduit, or the like, or any electrical generator(s) or other power source) may be made to fit, where by “box” we mean to say a rectilinear space or volume. The base of such a box, whose length is L and whose width is W, is then considered the rectilinear footprint of the system 110. In preferred embodiments, the aspect ratio of the box or space 218 is within reasonable limits, e.g., the ratio of any two of L, W, and H may be in a range from 5 to ⅕, or from 4 to or from 3 to ⅓.

In many cases, the space 218 is desirably of a size to allow the system 110 to be mounted on or in conventional land, water, or air vehicles, such as conventional trucks, trains, boats, airplanes, or helicopters, such that the system is mobile and can be moved from place to place,

For example, the space 218 may have dimensions equal to or less than those of standard shipping containers, such as: 20 ft long by 8 ft wide by 8.5 ft high, fora volume of 1,360 ft³ (38.5 m³) and a footprint size of 160 ft² (15 m³); or 20 ft long by 8 ft wide by 9.5 ft high, for a volume of 1,520 ft³ (43 m³) and a footprint size of 160 ft² (15 m²); or 40 ft long by 8 ft wide by 9.5 ft high, for a volume of 3,040 ft³ (86 m³) and a footprint size of 320 ft² (30 m²). Alternative useful sizes include: 5 m long by 2 m wide by 3 m high, for a volume of 30 m³ and footprint size of 10 m²; or 4.3 m long by 2 in wide by 2.8 in high, for a volume of 24.1 m³ and footprint size of 8.6 m²; or 4 in long by 2 m wide by 2.7 m high, for a volume of 21.6 m³ and footprint size of 8 m². The rectilinear space 218 may thus have a volume of less than 100 m³, or less than 50 m³, or less than 40 m, or less than 30 m³, or in a range from 20 to 30, or 20 to 40, or 20 to 50, or 20 to 100 m³. The footprint size may be less than 30, or less than 20, or less than 10 m², or may be in a range from 5 to 10, or 5 to 20, or 5 to 30 m².

The system 110 is also preferably sized and configured to process the septage 102 at flow rates that are suitable for at least light residential, residential, or light industrial applications. For example, if the system 110 receives and processes the septage 102 at an input flow rate F1, F1 is preferably at least 1 L/sec, or at least 2 L/sec, or at least 3 L/sec, or in a range from 1-5 L/sec, or 1-4 L/sec, or 2-4 L/sec. Even higher flow rates can be used by appropriately scaling up the systems as desired.

FIG. 3 illustrates a conventional truck 303 on which is mounted a compact filtering system of the type disclosed herein, the filtering system being represented schematically in this figure by the rectilinear space 218 discussed in connection with FIG. 2. The truck 303 may be of the type that is adapted for travel not only on paved roads but also on unpaved or uneven back roads or trails such as may be found in remote or impoverished areas of the world. The truck 303 includes, among other things, a cab 304 and a bed (truck bed) 305. The size and weight of the filtering system, and its mechanical configuration, make it particularly well suited and adapted for mobile use, e.g. capable of fitting onto the truck bed 305 without causing the truck to be overloaded or unstable, and adapted for secure attachment to the truck bed 305. In the depicted embodiment, the filtering system is compact enough so there is also space available on the truck bed 305 to mount other pieces of equipment, such as a conventional electric generator 306. The generator 306, which may be powered by gasoline, diesel fuel, LP gas, natural gas, or other conventional fuels, is preferably sufficient to supply all electrical power needs of the filtering system 110. Depending on the power requirements of the filtering system, as well as local climate conditions and other factors, alternative power sources may also be used to power the filtering system, such as one or both of solar panels and wind turbines.

Many embodiments of the system 110 are compatible with a total electrical power budget (for all electrical components of the system, including pumps, motors, sensors, actuators, control system, and so forth) of less than 100 kW, or less than 75 kW, or in a range from 25-100 kW, or 25-80 kW, or 50-80 kW.

One of the many applications of the disclosed filtering systems is improving the sanitation and health of underdeveloped and impoverished areas of the world. in that regard, such filtering systems may be dispatched to such areas to provide quick, affordable, safe, and environmentally sound emptying of pit latrines and septic tanks, which are not connected to any centralized sewage treatment facility.

Currently in order to empty such latrines, septage from the latrines must be pumped into a tanker truck, sometimes referred to as a vacuum tuck or fecal sludge truck. The tanker truck is driven to one latrine after another until the latrines are empty and the tank is full of septage.

(Such tanker trucks have tank capacities ranging typically from 10 to 55 m³, although larger or smaller tanker trucks may also be used.) When the tank is full of septage, the tanker truck is driven to a standard industrial, municipal, or regional wastewater treatment facility, where the contents of the tank are emptied and processed. The process can then be repeated by driving the tanker truck to additional sites where additional latrines can be emptied, and their contents processed again at the stationary treatment facility.

At least some embodiments of the filtering systems 110 disclosed herein can be used to substantially reduce the cost, increase the efficiency, anther increase the frequency of the latrine-emptying process, thus allowing for improved health and sanitation conditions of such communities. One way this can be, done is by using a mobile truck-mounted filtering system such as that of FIG. 3. In one scenario, the mobile filtering system and a tanker truck as described above would be driven together to the various latrine sites. At each site, the latrine contents are, emptied initially into the mobile filtering system. The mobile filtering system processes the septage as shown in FIG. 1, separating the septage 102 into debris 112, sludge 114, and clear water 116. The debris 112 is typically small in volume and can be placed in an on-site container for safe disposal, and the clear water 116 is clean enough to be safely emptied onto the ground or environment on-site next to the latrine, optionally even for useful purposes such as irrigation. Thus, of the original septage 102, only the more concentrated sludge 114 remains to be processed. The sludge 114, whose volume is roughly half (or less) of the initial volume of the septage 102, is pumped into the tanker truck by the mobile filtering system. In this way, many more latrines (roughly twice as many, or more) can be emptied before the tank of the tanker truck is full. This substantially reduces the amount of time and energy required for the tanker truck to drive to and from the stationary wastewater treatment facility, thus greatly improving efficiency.

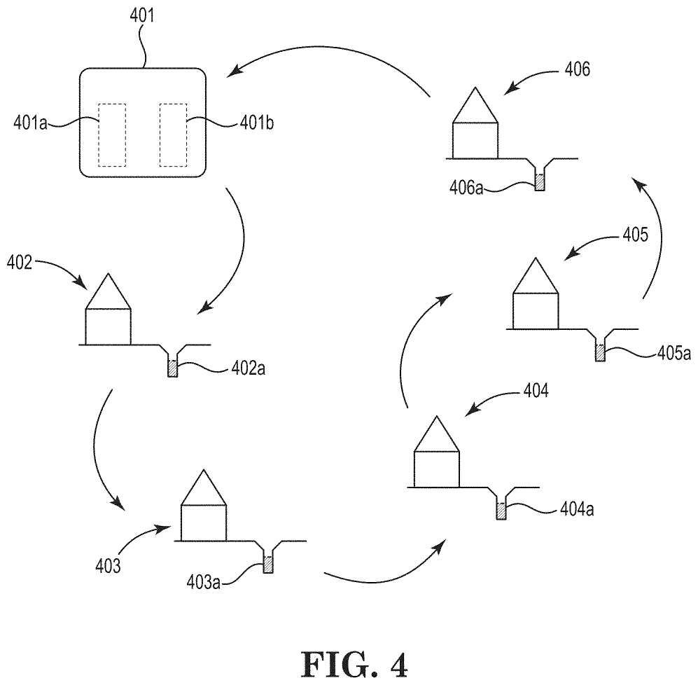

In reference to this latrine-emptying procedure, FIG. 4 schematically depicts a possible service route for the mobile truck-mounted filtering system of FIG. 3, in combination with a suitable tanker truck. In FIG. 4, the mobile filtering system may begin its day at a starting position or home base 401. It may then travel, together with a tanker truck, to a series of homes, villages, or sites 402, 403, 404, 405, 406, near which are respective latrines 402a, 403a, 404a, 405a, and 406a. At each such site, septage from the latrine is processed by the mobile filtering system into separate debris, sludge, and clear water outputs. The debris and clear water are safely disposed of or collected on-site, and the processed sludge is transferred to the tanker truck. At the end of the day, the mobile filtering system may return to its home base 401 while the tanker truck takes the processed sludge far away to the wastewater treatment facility.

The home base 401 facility may in some cases be equipped with cleaning infrastructure or equipment such as large off-line buffer tanks 401a, 401b. In this regard, the filtering system 110 may omit large buffer tanks or other cleaning equipment in order to be as compact and portable as possible. The filtering system 110 may thus in some embodiments require periodic, e.g. daily, cleaning operations, including in some cases access to large external (off-line) buffer tanks, in order to keep the filtering system 110 fully functional over long periods of time, e.g., weeks, months, or years. Such external cleaning requirements for the disclosed filtering systems are discussed further below.

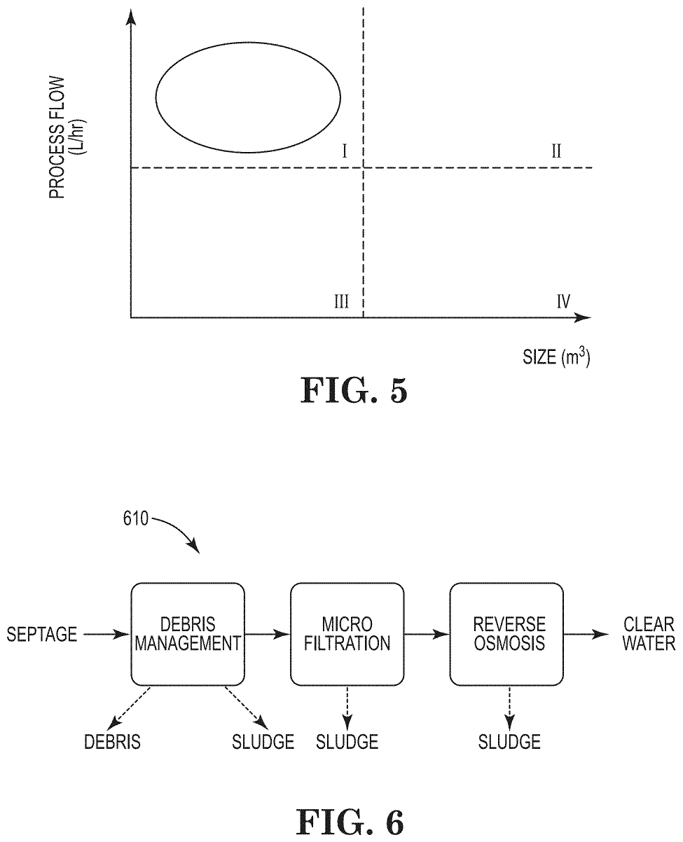

Besides having a relatively compact or small size, the disclosed filtering systems 110 also preferably have relatively fast processing times. Referring back to the latrine-emptying procedure described above, efficiency gains world not be realized if the processing speed of the filtering; system was too slow, i.e., if the time required to fully separate the initial septage 102 into the three distinct outputs was excessive. Consequently, the disclosed filtering systems preferably can accommodate high process flow speeds. The combination of desired characteristics for the disclosed filtering systems is shown in the simplified graph of FIG. 5. The graph plots process flow, e.g. as measured in liters/hr or other suitable units, versus system size as discussed in connection with FIG. 2, and measured in cubic meters or other suitable units.

The graph of FIG. 5 is divided into four quadrants: small size and high process flow (I) large size and high process flow (II), small size and low process flow (III), and large size and low process flow (III). Conventional municipal wastewater treatment facilities are generally very large in size and have high process flow capabilities, i.e., fall generally within quadrant II. Laboratory, handheld, or otherwise small-scale wastewater treatment systems are generally small in size but have low process flow capabilities, i.e., fall generally within quadrant III. Many important applications of the disclosed filtering systems 110, such as the mobile latrine-emptying application of FIG. 4, involve systems that fall within quadrant I, hence that quadrant is circled in FIG. 5.

FIG. 5 should not, however, be interpreted in an unduly restrictive fashion. For example, although some disclosed filtering systems 110 may be constructed to be compact enough to be easily vehicle-mountable, such systems can also be readily scaled up or down in size as desired (within practical limits) to yield larger or smaller systems. We therefore also make reference throughout this document to a volumetric flux parameter as another way to characterize the filtering systems 110. The volumetric flux parameter may be expressed as a ratio of the flow rate (F1) at which the filtering system receives the wastewater divided by the volume (VS) of the filtering system as discussed in connection with FIG. 2. The volumetric flux parameter is thus F1/VS, and may be expressed in units of liters per hour per cubic meter, L/(m³hr), or more simply in units of inverse hours (hr⁻¹), or other suitable units. Preferably, the disclosed systems can achieve F1/VS of at least 0.2 hr⁻¹, or at least 0.3 hr⁻¹, or at least 0.5 hr⁻¹, or in a range from 0.2-0.6 hr⁻¹, or in a range from 0.3-0.6 hr⁻¹. While satisfying this condition such system also preferably is configured such that, for wastewater having a total suspended solids (TSS) content of TSS1 (such as 200 or 500 mg/L) and a chemical oxygen demand (COD) of COD1 (such as 2,500 or 3,000 mg/L): the system receives the wastewater at the flow rate Rand provides the primary output at least in part while receiving the wastewater; the primary output has a flow rate F2, where F2 is at least 40%, or at least 50%, or at least 60% of F1; and the primary output has a TSS of less than 1% or 0.4% of TSS1 (e.g. 2 mg/L), a COD of less than 2% or 1.7% of COD1 (e.g. 50 mg/L), and a turbidity of less than 1, or 0.5, or 0.3 NTU. The parameter F2 may also desirably be in a range from 40-80%, or 50-80%, or 60-80% of F1. The system may also satisfy the treatment capabilities set forth in any one or more of Tables 1 through 4 above, in whole or in part.

Besides being physically compact as characterized by the volumetric flux, the disclosed systems 110 are also preferably energy efficient. The disclosed filtering systems may thus also or alternatively be characterized by a parameter referred to herein. as “Energy Consumed per Volume Processed”, or ECVP. The ECVP is a measure of how much energy is requited by the system to process a given volume of input septage and can be calculated by dividing the system electrical power (e.g. instantaneous or averaged over a given time) by the (instantaneous or averaged) input flow rate (F1). ECVP may thus be expressed in units of kW*hr/m³. For maximum energy efficiency, low values of ECVP are desired. Preferably, the disclosed filtering systems can achieve an ECVP of no more than 30, or 20, or 10 kW*hr/m³, or in a range from 1-30, or 1-20, or 2-10 kW*hr/m³.

In order to provide the desired combination of system size, flow rate, and cleaning capability, we have found it useful in many cases to arrange the filtering system as shown generally in the system 610 of FIG. 6. In such cases the filtering system includes three main subsystems: a debris management (DM) section, a microfiltration (MF) section, and a reverse osmosis (RO) section. The DM section receives the incoming septage or raw wastewater, and does a first level separation between large debris, such as sticks, rocks, and trash, and smaller matter, such as particles whose size is in a first size range. The large debris may be sent to a suitable trash can or collection bin, while the smaller matter forms part of an output sludge stream. Partially filtered septage released by the DM section is then fed to the MF section. The MF section removes more particles—of a second size range smaller than the first size range—from the partially filtered septage. The smaller particles are diverted by the MF section to the output sludge stream. The still further filtered septage released by the MF section is fed to the RO section. The RO section removes still more particles—of a third size range smaller than the first size range—from the partially filtered septage. These smallest particles are diverted by the RO section to the output sludge stream. The fully filtered septage is released by the RO section as the clear water 116 of FIG. 1. The three sludge streams generated by the three sections larger particles from the DM section, smaller particles from the MF section, and smallest particles from the RO section—combine to provide the sludge 114 of FIG. 1.

Alternative embodiments may add or subtract subsystems relative to the system 610 of FIG. 6. For example, in some embodiments, the RO section may be omitted. In other embodiments, all three subsystems of FIG. 6 may be used, and an additional filtering subsystem added after the RU section so as to provide as output clear water that is fully potable.

Still in reference to FIG. 6, the DM section may be said to have a DM input, a DM filtered output, and a DM concentrated output. The MF section may be said to have a first input, a first filtered output, and a first concentrated output. The RO section may be said to have a second input, a second filtered output, and a second concentrated output. The first input thus couples to the DM filtered output, and the second input couples to the first filtered output. The second filtered output is the clear water, which we may refer to as a primary output of the filtering system. The DM concentrated output, the first concentrated output, and the second concentrated output combine to form the output sludge stream, which we may refer to as a secondary output of the filtering system. In exemplary embodiments, the MF and RO sections both include cross-flow membrane filtration elements as discussed further below. In exemplary embodiments the system may also include an intermediate tank coupled to receive the first filtered output, and a valve configured to selectively couple contents of the intermediate tank to the first input. In exemplary embodiments, F1/VS for the filtering system is at least 0.2 hr⁻¹, or at least 0.3 hr⁻¹, or at least 0.5 hr⁻¹, or in a range from 0.2-0.6 hr⁻¹, or in a range from 0.3-0.6 hr⁻¹.

Microfiltration (MF) devices are, of course, known. Microfiltration is a physical filtration technology in which a contaminated fluid passes through a permeable membrane. Water and particles smaller than the pore size pass through the membrane, while larger particles are blocked or trapped. The particle cutoff size, above which particles are trapped and below which particles may pass, typically ranges from 0.1 micrometers to 10 micrometers, although larger and smaller sizes can also be used. The actual value of the particle cutoff size depends on the characteristics of the particular membrane selected.

A simple tubular cross-flow MF device 720 is shown in FIG. 7. A contaminated fluid 702a, such as septage or wastewater 102 discussed above, or such wastewater that has been pre-filtered by a DM device, is made to flow through a hollow tube 722 whose wall may comprise a suitable membrane layer such as PVDF and other optional layers. The fluid flows tangentially across the membrane at a relatively high flow rate. Water, and particles smaller than the pore size, pass through the membrane wall to provide a filtered fluid 702b (permeate). Larger particles, along with some water, remain inside the tube 722 until exiting, the opposite end, to provide concentrated fluid 702c (retentate) as shown. The filtered fluid 702b collects in a space 726 between the hollow membrane and an outer jacket or shroud 724, and is provided as a filtered output, separate from the concentrated output provided by the concentrated fluid 702c.

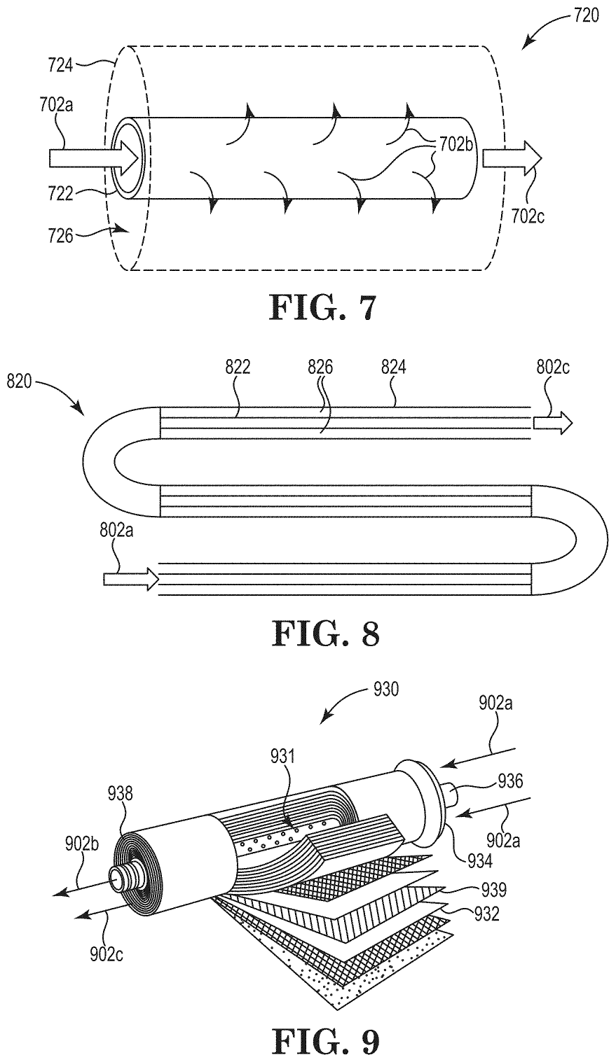

FIG. 8 shows a tubular cross-flow MF device 820 similar to that of FIG. 7 but with multiple MF modules in a serpentine or coiled arrangement, connected by u-bends. The MF modules in device 820 thus each includes a hollow tube 822 similar, to tube 722 of FIG. 7, and an outer jacket or shroud 824. Contaminated fluid 802a is pumped through the hollow tube 822. The fluid again flows tangentially across the membrane at a high flow rate. Water and particles smaller than the pore size pass through the membrane to the space 826 between the tube 822 and the shroud 824, and this fluid is carried off as a filtered output (permeate). The remaining fluid exits the distal end of the tube 822 as concentrated fluid 802c (retentate). The serpentine configuration of device 820 is beneficial for space-savings and compactness by fitting long lengths of membrane tubing in a small physical space.

Although both FIGS. 7 and 8 show only one hollow membrane tube being present inside the outer shroud (for simplicity), in practice the efficiency of the device can be enhanced by including groups or bundles of such hollow tubes within the shroud 724, 824. Furthermore, trains of multiple membranes, or MF devices, in series can also be employed to increase throughput and efficiency, e.g. as reflected in the serpentine arrangement of FIG. 8.

Reverse Osmosis (RO) devices are also known. RO technology accomplishes filtration or separation by use of a semipermeable membrane together with an applied pressure to overcome osmotic forces. The cutoff particle size for RO devices can be as small as 0.1 nanometers. Spiral-wound RO devices utilize cross-flow of the input fluid and relatively high flow rates in a compact size.

A conventional spiral wound RO cartridge or element 930 is shown in FIG. 9. As shown in the figure, an RO semipermeable membrane 932 is layered between spacers 939 and spiral wound around a central perforated tube 931. Unpurified water 902a enters a first portion 934 of RO cartridge 930 and permeates through RO semipermeable membrane 932 and spacers 939 to central perforated tube 931, which is capped by cap 936 at first portion 934 to prevent unpurified water 902a from entering central perforated tube 931. Flow through RO semipermeable membrane 932 produces concentrate 902c and purified water 902b. Once unpurified water 902a enters central perforated tube 931, it becomes purified water 902b because it has been filtered by semipermeable membrane 932. Purified water 902b exits a second portion 938 of RO cartridge 930 through the central perforated tube 931. One advantage of winding semi-permeable membrane 932 around perforated tube 931 is an increase in membrane area per unit volume, thereby improving flow rate and efficiency in removing contaminants. Spacers 939 may promote turbulent flow that decreases membrane fouling by keeping unruffled water 902a velocities, pressures, and other flow quantities constantly and randomly fluctuating. Contaminants within water are, thus, less able to settle and foul the semipermeable membrane 932. A more detailed description of the RO element 930 can be found in U.S. Pat. No. 7,947,181 (Cartwright).

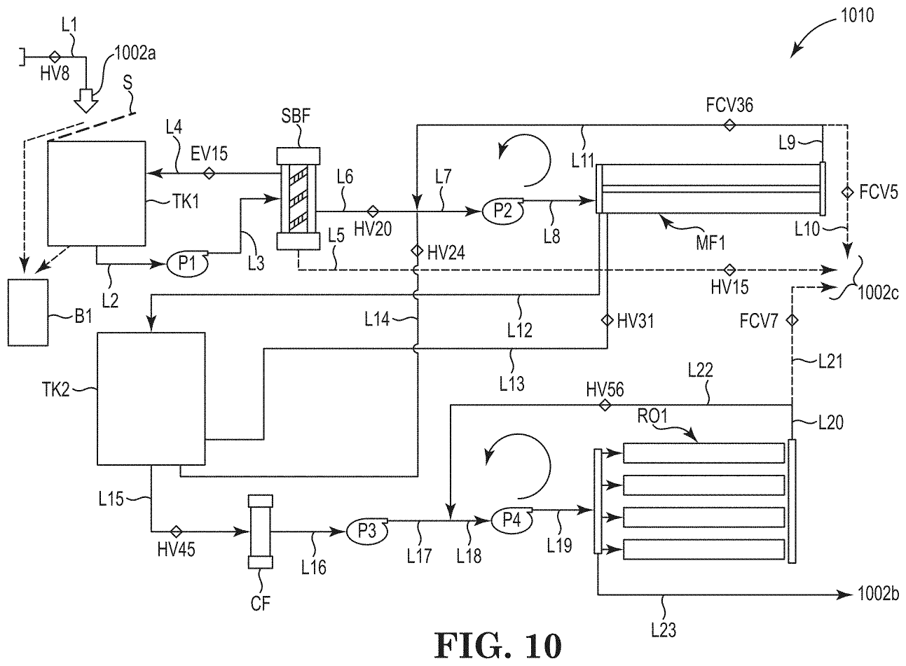

Another diagram of a filtering system suitable liar cleaning wastewater and the like as discussed herein is shown in FIG. 10. The system 1010 receives septage or other wastewater 1002a through a receiving tube or line L1. Similar to the system 610 of FIG. 6, the system 1010 separates the incoming wastewater 1002a into three main streams or outputs: (1) debris, which may be collected in a hand B or other receptacle, (2) clear water loon, and (3) concentrated sludge 1002c. The cleanliness or purity of the clear water 1002b, obtained from typical septage as input material, is preferably as discussed above in connection with any or all of Tables 1-4. The volume or amount of the clear water 1002b is preferably at least 40%, or at least 50%, or at least 60% of the volume of the incoming wastewater 1002a. Stated differently, the steady-state flow rate (F2) of the clear water 1002b is preferably at least 40%, or at least 50%, or at least 60% of the steady-state flow rate (F1) of the incoming wastewater 1002a, e.g. as measured in line L1 or line L2. Moreover, the system 1010 preferably fits within a rectilinear space of volume VS, and F1/VS is preferably at least 0.2 hr⁻¹, or at least 0.3 hr⁻¹, or at least 0.5 hr⁻¹, or in a range from 0.2-0.6 hr⁻¹, or in a range from 0.3-0.6 hr⁻¹. We have found that such requirements can be achieved using systems of the type shown in FIG. 10.

Similar to system 610, the system 1010 includes three main subsystems or sections: a DM (debris management) section, an MF section, and an RO section. Main elements of the DM section include a first tank TK1, a pump P1, and a spiral brash filter SBF. Main elements of the MF section include an MF device MF1, a pump P2, and a second tank TK2. Main elements of the RO section include pumps P3 and P4, and an RO device RO1. These three sections further comprise, or are connected by, respective pipes, tubes, or lines L1 through L23, as well as fluidic valves such as HV8, EV15, HV15, HV20, FCV5, FCV36, HV24, HV31, HV45, HV56, and FCV7 as shown. The system 1010 may also include electronic control panel(s) or system(s) (not shown) to optimally manage the operation of the system according to any predefined modes of operation. Various transducers or sensors such as temperature sensors, flow sensors, pressure sensors, and the like may be employed as inputs to the control system to monitor process parameters or ensure optimal performance. Such a control system may also monitor or control the operation of any or all of the previously listed fluidic valves, as desired,

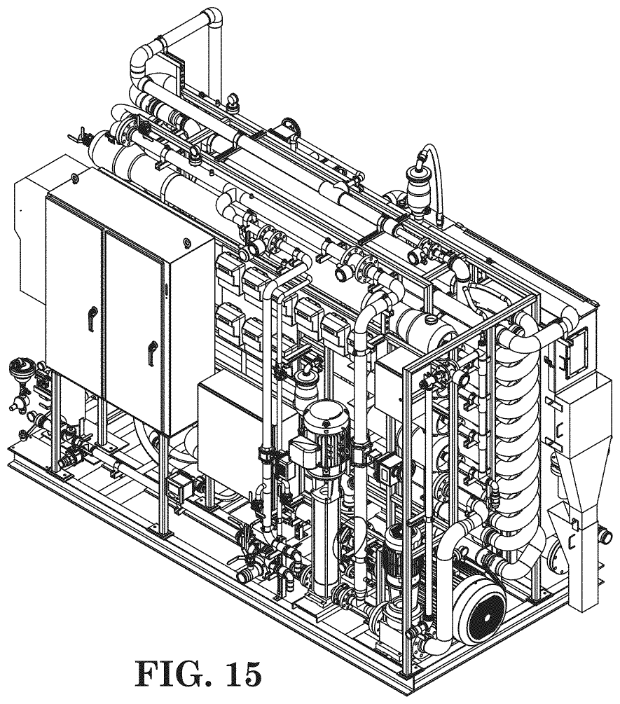

The electronic control system may include one or more digital processors, programmable logic controllers (PLCs), memory devices, input devices, output devices, and communication devices. The memory devices may include both volatile memory and non-volatile memory, as well as random access memory (RAM), read only memory (ROM), and other known types of memory. A chief function of the memory is to store computer readable instructions used by the processor(s) to control, manage, and coordinate the various operations of the system 1010 as described herein. Input devices may include touch screen(s), keyboard(s), trackball(s), knobs, buttons, switches, or the like, by which an operator can submit information or settings to the processor or other components, or otherwise configure the control system. Output devices may include display screen(s), display driver(s), LEDs, other lighting components, horns, buzzers, or the like. Communication devices may include transmitters, receivers, antennas, communication ports, signal generators, or the like, by which communication can occur between or among the processor(s), local or remote human operator(s), and sensors (such as flow sensors, temperature sensors, pressure sensors, and so forth) that may be included in the system 1010. The control system may be entirely or partially housed in one or more suitable electrical cabinets mounted alongside the pipes, tubes, and other fluid handling components of the system 1010, as shown most clearly m FIGS. 15, 16, 17, and 18 below.

Upon startup of the system 1010, e.g. when arriving at a latrine site or otherwise, an external pumping device (which may not be part of the system 1010) is used to force septage or wastewater 1002a through line L1 into the first tank TK1. The tank TK1 may serve to hold a limited amount of septage, e.g. having a capacity of from 100-300 gallons (or 350 to 1,200 liters) or from 200-250 gal (or 750 to 950 liters), to prevent overflow. One or more mesh, wire, or bar screens S may be employed above the tank TK1 to capture and separate relatively, large debris such as the light debris and heavy debris discussed above. Such debris may slide down the screen. S or may be scraped by an operator into the barrel B1 for incineration or disposal. To the extent other relatively large debris, such as stories or rocks, fall through the screens S and sink to the bottom of the tank TK1, such debris may also be removed via a rock trap or the like provided at the bottom of the tank, and transferred to the barrel B1 as shown.

Septage that is free or substantially free of the larger debris may then be pumped via pump P1 to a suitable filter or separation device, such as a spiral brush filter SBF. The flow rate produced by pump P1 in the line L2 may be any suitable value but in some embodiments may be at least 1 liter per second (L/sec), or at least 2 L/sec, or at least 3 L/sec, or in a range from 1-4 L/sec or in a range from 2-4 L/sec. This flow rate may be considered to be the flow rate at which the system 1010 receives the wastewater, and may be referred to herein as F1. The SBF or other initial separation device has an input at line L3, a concentrated output at line L5, and a filtered output at line L6. In some embodiments the SBF may remove particles greater than 100 micrometers in size, whereupon such particles are directed to the concentrated output, while smaller particles and water are directed to the filtered output.

The filtered output of the SBF passes via line L6 and through valve HV20 to the MF section. A pump P2 draws such fluid through line L7 and then L8 into the MF device MF1. The MF device has all input at line L8, a filtered output (permeate) at lines L12 and L13, and a concentrated output (retentate) at line L9. By appropriate control of valves FCV5 and FCV36, some of the concentrated output can be recycled through lines L11, L7, and L8 to maintain an adequately high flow rate through the MF device, while the remainder of the concentrated output can be directed through line L10 shown. At this point, the valves HV24 and HV31 may be closed.

The filtered output from the MF device MF1 is directed along line L12 to a second tank TK2, referred to alternatively as an intermediate tank. The tank TK2 thus collects the filtered liquid from the MF device. The tank TK2 may have a fluidic capacity of from 100-300 gallons (or 350 to 1,200 liters) or from 200-250 gal (or 750 to 950 liters), and may in some embodiments have the same or similar capacity as the tank TK1. In some embodiments the device MF1 may remove particles greater than 0.1 micrometers in size, whereupon such particles are directed to the concentrated output (line L9), while smaller particles and water are directed to the filtered output (line L12).

The filtered output of the device MF1 is drawn from the tank TK2 via line L15 and through valve HV45 to the RO section. Accordingly, a pump P3 draws such fluid through line L15, through an optional cartridge filter CF, and through line L17. Another pump P4 draws the fluid through lines L18 and L19 into the RO device RO1. The RO device has an input at line L19, a filtered output at line L23, and a concentrated output at line L20. By appropriate control of valves FCV7 and HV56, some of the concentrated output can be recycled through lines L22, L18, and L19 to maintain an adequately high flow rate through the RO device, while the remainder of the concentrated output can be directed through line L21 as shown.

The filtered output from the RO device RO1 is directed along line L23 to provide. the primary output of the system 1010, namely, the clear water 116 discussed above. The flow rate of this primary clear water output is referred to herein as F2, and its preferred relationship to the steady-state wastewater receiving flow rate F1 is discussed elsewhere herein. Due to the time needed for fluid to work its way through the system 1010, e.g. from the DM section to the MF section to the RO section, there may be a delay between the time the flow rate F1 reaches steady state and the time the flow rate F2 reaches steady state; however, in most embodiments, the primary output is provided at least in part while the wastewater is being received through the line L2.

In some embodiments the device RO1 may remove molecules (particles) greater than 200 Daltons in size, whereupon such particles are directed to the concentrated output (line L20), while smaller particles and water are directed to the filtered output (line L23). Concentrated outputs from lines L5, L10, and L21 are combined to provide a system secondary output of concentrated sludge or waste 1002c.

The system 1010 is simplified relative to many known systems, and is notably free of (and hence it omits or may omit) one, some, or all of: aeration tanks, settling tanks, reaction tanks, off-line buffer tanks, chemical reactions, chemical coagulants, chemical additives, biological processes, electro-coagulation, oxidizing agents, combustion, electrolysis, and sacrificial electrodes. This simplification allows the system 1010 to have a compact size in terms of system volume VS or footprint area. Of particular note is the absence of any off-line buffer tanks, which tend to be very large. “Very large” in this context may refer to a volume of, for example, at least (a) 500 gallons (or 1,900 liters), or (b) a volume corresponding to 10, or 20, or 30 minutes of detention time, or (c) both (a) and (b). In this regard the system 1010 may include no tank whose capacity is greater than the greater of the capacity of tank TK1 and the capacity of tank TK2. Furthermore, to the extent the tank TK2 could itself be construct as a buffer tank, it is in-line with (and an integral part of) the system 1010, rather than off-line, and it is preferably not “very large” as discussed above.

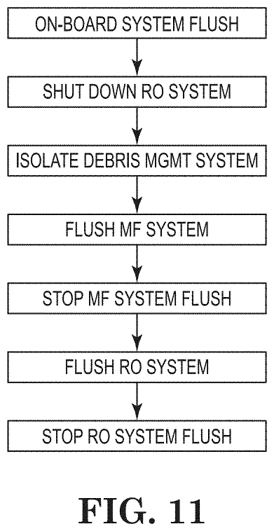

In conventional systems, buffer tanks do however serve an important purpose of flushing and cleaning the system to prevent particle buildup and blockage of filter or separation elements. Referring back to the discussion of FIG. 4, the system 1010 is designed to operate for substantial periods without being connected to large buffer tanks 401a, 401b, and in this way the system size can be greatly reduced. In order to operate in this fashion, the system 1010 provides for a unique on-board system flush to help delay the need for a full cleaning/flushing using large buffer tanks.

Whereas in the usual mode of operation of system 1010, as described above, the DM filtered output from the DM section is received via lines L6 and L7 by the MF section, and the first filtered output from the MF section is received via line L12 by the intermediate tank TK2, and contents of the intermediate tank are directed to the RO section via line L15, in a second (onboard system flush) mode of operation, the DM section and the RO section are fluidly isolated, or substantially fluidly isolated, from the MF section, and the contents of the intermediate tank TK2 are received by the MF section, and the first filtered output from the MP section is received by the intermediate tank. The on-board system flush mode of operation can be accomplished in the following way: (1) pumps P3 and P4 are stopped and valve HV45 is closed to shut down and fluidly isolate, or substantially fluidly isolate, the RO section from the MF section; (2) pump P1 is then stopped and valve HV20 is closed to shut down and fluidly isolate, or substantially fluidly isolate, the DM section from the MF section; (3) filtered liquid already present in the intermediate tank TK2 is then used to forward flush the MF device MF1 by opening valve HV24, such that the pump P2 draws the filtered liquid from the tank TK2 to the MF device MF1, and while this is happening, valve FCV5 is opened and valve FCV36 is closed, such that the liquid in the tank TK2 is partially drawn down; (4) thereafter, stopping the MF device forward flush by stopping pump P2, closing valves HV24 and FCV5, and opening valve HV31 to allow doubly-filtered retentate in the MP device MF1 to flow by gravity into the tank TK2 through line L13 (at least a portion of MF1 is preferably situated above at least a portion of the tank TK2 to permit this), thus to at least partially fill the tank TK2 with doubly-filtered retentate from MF1; and (5) initiating a forward flush of the RO device. using this doubly-filtered retentate by closing valve HV56, opening valves HV45 and FCV7, and starting pumps P3 and P4 to draw the retentate through lines L15, L16, L17, L18, and L19 to the RU device RO1. These procedures of the on-board flush, which may be executed automatically by a suitably programmed electronic control system, are shown in the flow diagram of FIG. 11.

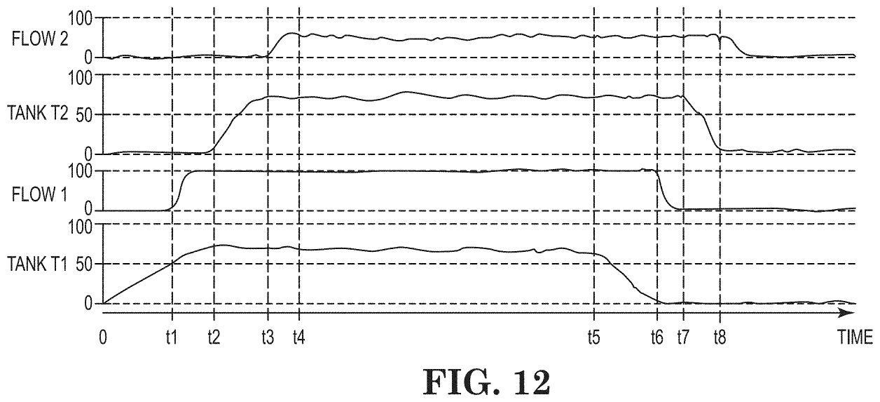

A collection of idealized waveforms representing the function or status of various elements of the filtering system 1010 as a function of time is shown in FIG. 12. In this figure, the system is assumed to be in its normal mode of operation, not the on-board flush mode in the immediately preceding discussion. The first curve, labeled “tank T1”, may represent a fluid level in the tank TK1 of FIG. 10. The tank may start out empty at time 0, at which time septage 1002a begins to flow into the tank via line L1. The fluid level in TK1 rises until it reaches a roughly steady state at time t2. The second curve, labeled “Flow1”, may represent the wastewater receiving flow rate F1 discussed above, e.g., the flow rate in line L2. This flow rate starts at zero but rises rapidly at about time t1, when the pump P1 turns on, soon achieving a steady-state level. The third curve, labeled “tank T2”, may represent a fluid level in the tank TK2. This tank may also start out empty, but begin to till at a time t2, shortly after the flow rate in line L2 reaches steady-state, and reaching a steady-state level at about time t3. The fourth curve, labeled “Flow2”, may represent the primary system flow rate F2 discussed above, e.g. the flow rate in line L23. This flow rate may start from zero but rise rapidly around the time t3, achieving a steady-state value at time t4. Between time t4 and t5 the system 1010 is in steady state, with flow F1 occurring simultaneously with flow F2. At around time t5, septage from the line L1 stops, whereupon the level in tank TK1 steadily declines as pump P1 steadily draws down the tank contents, reaching zero at time t6. At this point the pump P1 stops and the curve Flow1 drops to zero. Thereafter, at a liner time t7, the level in tank TK2 begins to fall, reaching zero at time t8. Shortly thereafter, the Flow2 in line L23 drops to zero.

Numerous modifications can be made to the disclosed filtering systems. We describe above in connection with FIG. 6, for example, a simplification in which the RO section of the system 610 may even be omitted. The same modification can also of course be made to the filtering system 1010 of FIG. 10. Such a modification may be desirable for end-use applications where a lower quality output fluid is acceptable. Benefits of the simplified design may include one, some, or all of: reduced system cost, reduced system complexity or maintenance, reduced system volume (VS), reduced electrical power requirements, and increased system fluid recovery. A consequence would be that the filtered output of the MF section (i.e. the MF effluent) would become the primary output (“clear water”) of the simplified filtering system. The biochemical specifications of the primary output would be of lower quality than those for a counterpart filtering system in which the RO section is not omitted. For example, for incoming wastewater having a total suspended solids (TSS) content of TSS1 and a chemical oxygen demand (COD) of COD1, the primary output of the simplified system may have a TSS of less than 1% or 0.4% of TSS1, a COD of less than 30%, 25%, 20%, 15%, or 10% of COD1, and a turbidity of less than 100, 80, 60, or 40 NTU.

### EXAMPLES

In accordance with the foregoing teachings, a prototype filtering system and components thereof were constructed and tested,

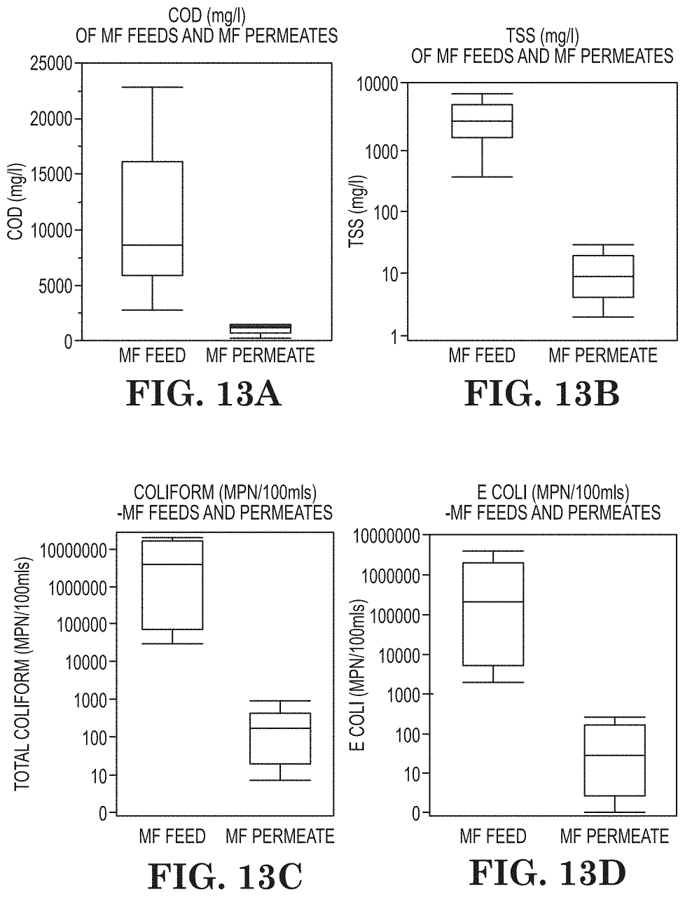

First, a crossflow MF device was obtained and tested, for suitability in a system'such as that of FIGS. 1, 6, or 10. The crossflow MF device was 1.2 meters long and contained 0.9 m² of membrane surface area. In total, 530 gallons (˜2,000 liters) of raw sewage were recirculated and ultimately filtered through the MF device using only a basket strainer as a pre-filter upstream of the MF device. Some results of the testing are shown in FIGS. 13A-D. FIG. 13A plots the range of COD observed for the input material (strained septage) and the corresponding range for the output permeate of the MF device. FIG. 13B plots the range of TSS observed for the input material and the corresponding range for the output permeate of the MF device. FIG. 13C plots the range of Total Coliform observed for the input material and the corresponding range for the output permeate of the MF device. FIG. 13D plots the range of E. Coli observed for the input material and the corresponding range for the output permeate of the MF device.

The following conclusions were drawn from the tests of the MF device:
MF consistently produces a clear (low turbidity) permeate with a yellow hue;
the MF permeate meets all liquid discharge requirements except COD and BOD (due to soluble portion);
MF flux values during septage treatment were not affected by solids concentration over the range tested (0.4-1.5%);

observed MF flux with septage is compatible with the desired functionality of a system such as that of FIGS. 1, 6, or 10; and
the MF permeate is clean enough to feed to RO membranes.

RO device was also obtained and tested for suitability in a system such as that of FIGS. 1, 6. or 10. The RO device was a 2.5-inch (˜1 cm) diameter by 40-inch (˜1 m) long spiral wound brackish water RO element with about 2.6 m² of membrane surface area. In total, 25 gallons (˜95 liters) of MF permeate (from the tests described above) were pumped directly into, recirculated through, and ultimately filtered through the RO device. The following conclusions were drawn from these tests:
brackish water RO membranes provide sufficient COD rejection to meet desired liquid discharge requirements at high rates of permeate recovery;
the observed RO flux is compatible with the desired system functionality; and
RO is effective to meet COD/BOD requirements based on expected soluble COD variability in the field,

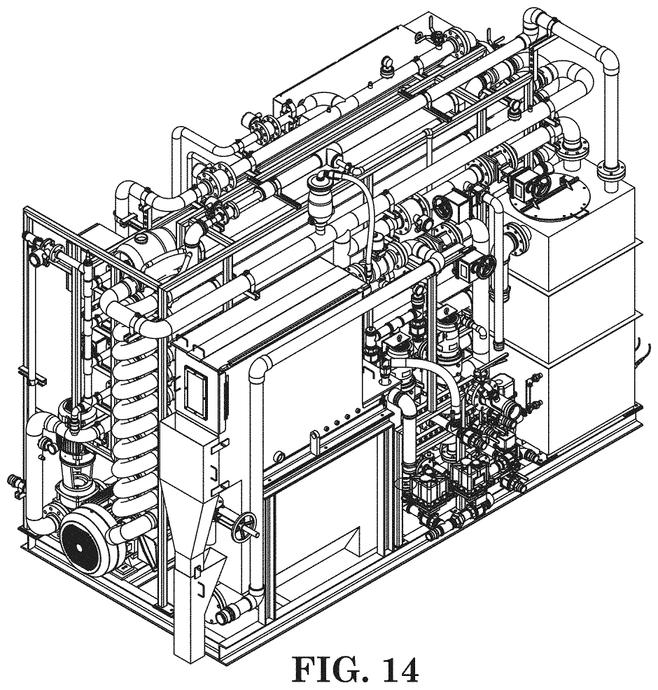

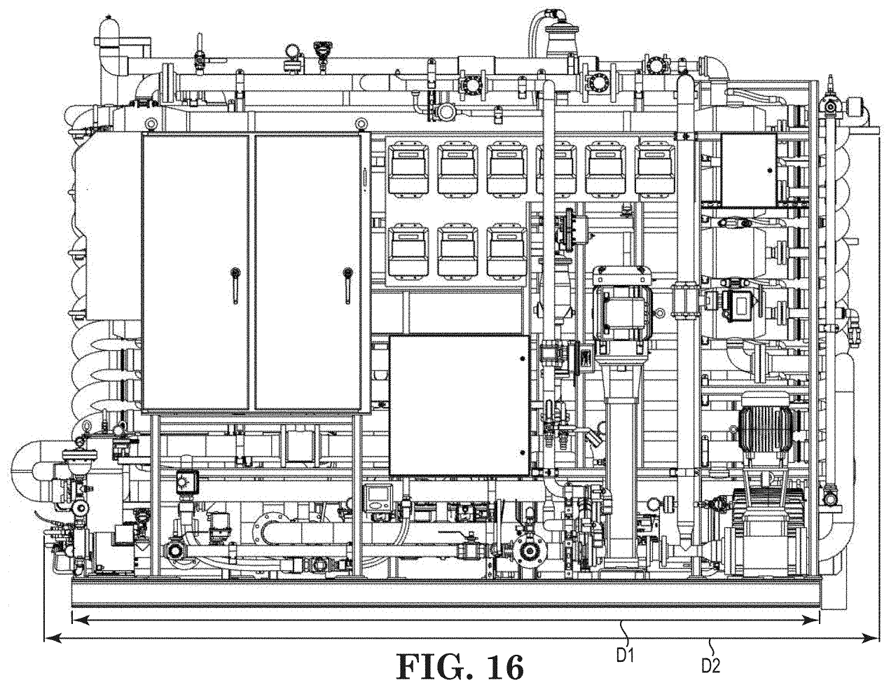

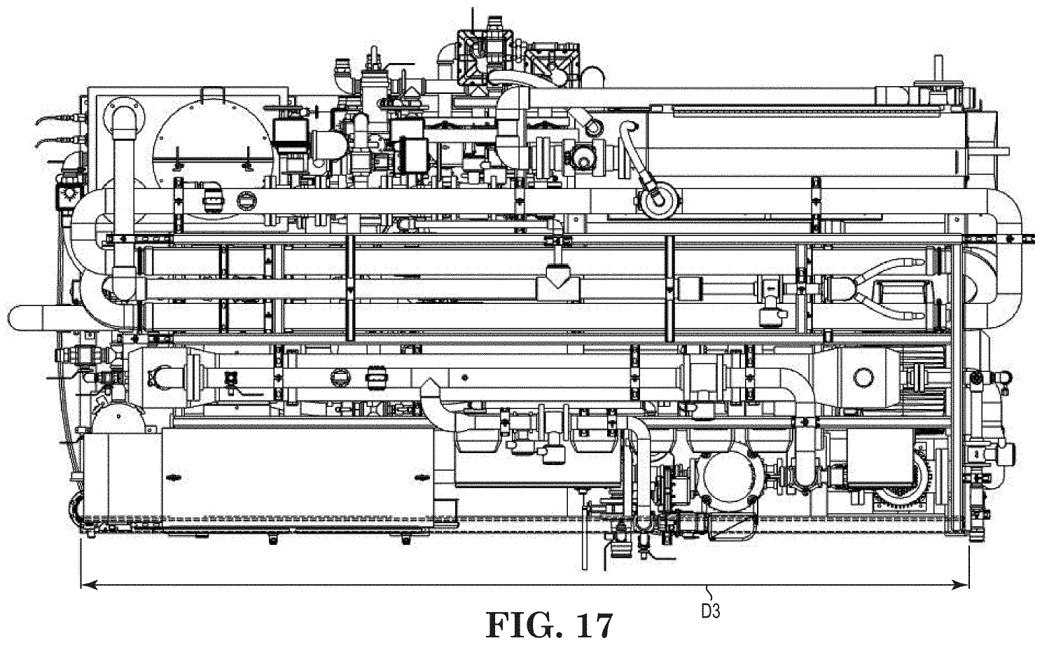

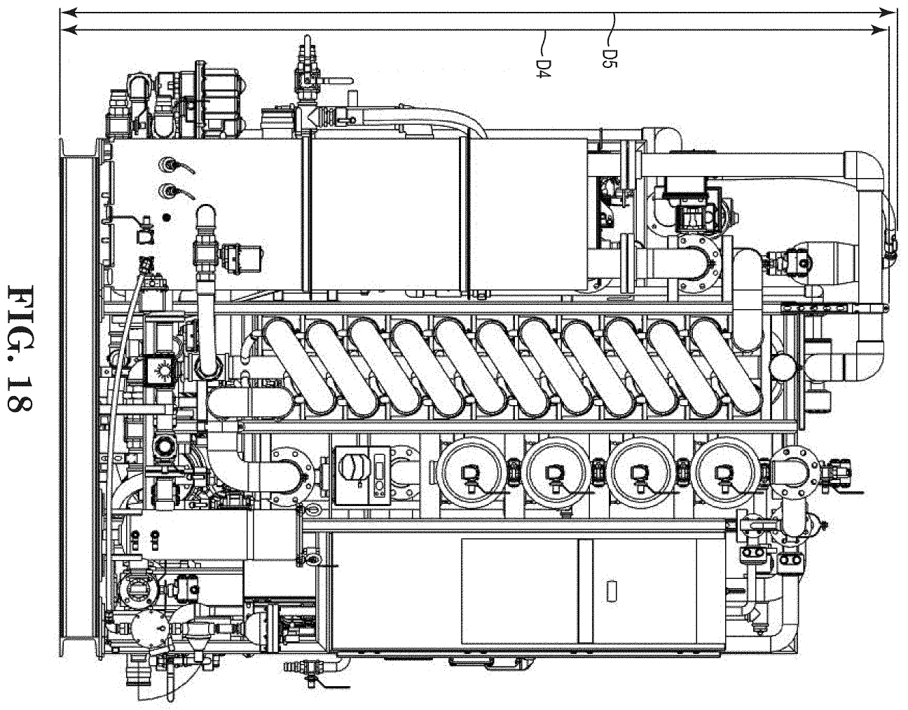

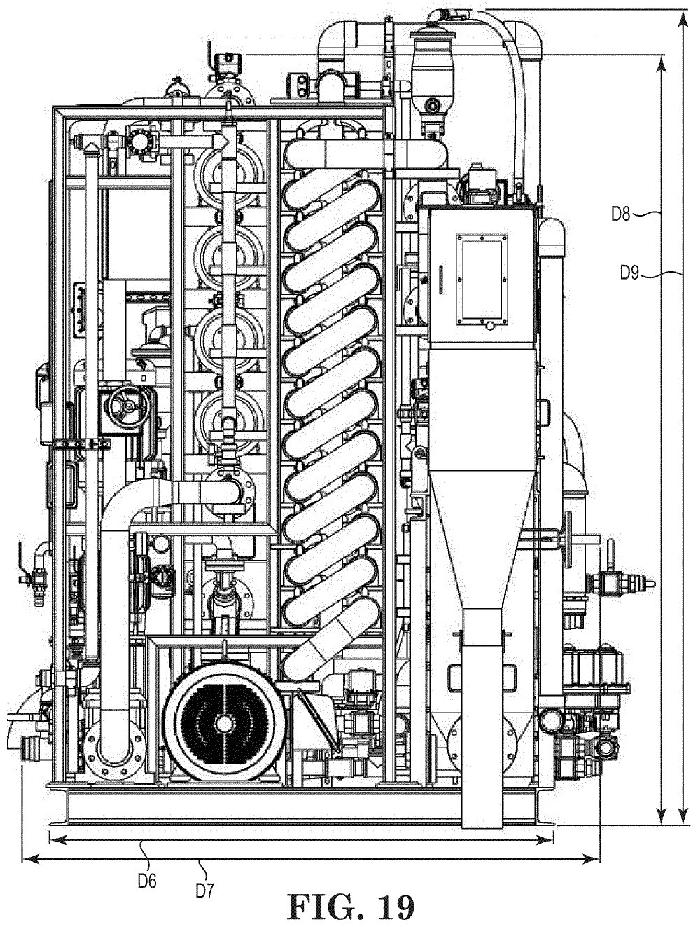

Thereafter, a filtering system as described herein was designed, constructed, and tested with actual sewage. Numerous trial runs were conducted over the course of many days. The constructed system, referred to herein as System 1.0, was substantially similar in layout to the system 1010 of FIG. 10. For the MF device MF1, two parallel trains of 12-ft long crossflow tubular membranes connected in series, comprising about 122 m² of total membrane surface area, were used. For the RO device RO1, four parallel pressure vessels, each containing three 8-inch (˜20 cm) diameter RO elements in series, comprising about 492 m² of total membrane surface area, were used. Computer-aided design (CAD) images of a filtering system substantially similar to the System 1.0 are provided in FIGS. 14 through 19, (CAD images of System 1.0 itself can be found in FIGS. 14-19 of priority document U.S. Ser. No. 62/794,878, filed Feb. 1, 2019, which is incorporated herein by reference. FIGS. 14-19 in the present document, which show in detail how a filtering system as described herein can be constructed and configured, include slight modifications relative to System 1.0. Differences between the two systems are not relevant to the present discussion.) In FIG. 14, the tank TK1 can be seen in the nearest corner (foreground) of the unit, and the tank TK2 can be seen at the right-most corner. Each of these tanks has a height that is almost equal to the overall height of the filtering system. In FIG. 15, the control panel can be seen at the left-most corner, and the tank TK1 can be seen at the right-most corner. In the elevation view of FIG. 16, cabinets that house the control panel can be seen on the left. In the top plan view of FIG. 17, the control panel (and cabinet) is at the lower left, the tank TK2 is at the upper left, and the tank TK1 is at the upper right. In the side elevation view of FIG. 18, the tank TK2 is at the left and the control panel is on the right, with a coiled MF device in between. In the opposite side elevation view of FIG. 19, the tank TK1 is on the right, with the coiled MF device to the left of it, in the center of the image. The dimensions D1 through D9 in FIGS. 16-19 are as follows: D1=4.0 m (159.38 inches); D2=4.7 m (184.976 inches); D3=4.1 in (159.565 inches); D4=3.2 m (126.213 inches); D5=3.2 m (127.441 inches); D6=2.0 m (78.76 inches); D7=2.3 m (90.437 inches); D8=3.1 m (122.36 inches); and D9=3.2 m (127.401 inches). As shown, the entire filtering system may be mounted on and supported by a single rectangular metal frame or base. In the illustrated system, the frame has dimensions of 2.0×4.0 meters, or 8 m².

The dimensions of the System 1.0 i.e., the dimensions of the smallest rectilinear space into which the system fit, were substantially 4.5 meters long by 2.2 meters wide by 3.2 meters high, for a total system volume VS of 31.7 cubic meters, and a footprint size of 10 m². The capacity of tank TK1 was 225 gallons (˜850 liters) and the capacity of tank TK2 was also 225 gallons (˜850 liters). Steady state flow levels F1, F2 (as described above) achieved (simultaneously) during testing with actual septage were as high as 3 L/s and 2 L/s respectively. Thus, the System 1.0 exhibited a value of F1/VS of 0.341 hr⁻¹. Straightforward hardware adjustments or modifications can be made to the System 1.0 to easily reduce the system size to 4.0 m long by 2.0 m wide by 2.7 m high, with the same or substantially the same performance characteristics, for a system volume VS of 22 m³, a footprint of 8 m², and a ratio F1/VS of 0.491 hr⁻¹.

The System 1.0 operated in such a way that, for wastewater having a total suspended solids (TSS) content of 200 or 500 mg/L and a chemical oxygen demand (COD) of 2,500 or 3,000 mg/L, the primary output had a TSS of less than 2 mg/L, a COD of less than 50 ) mg/L, and a turbidity of less than 1 NTU. The System 1.0 also operated in such a way that, for wastewater having a TSS content of TSS1 and a COD of COD1, the primary output had a TSS of less than 1%, and less than 0.4%, of TSS1, a COD of less than 2%, and less than 1.7%, of COD1, and a turbidity of less than 1 NTU.

The System 1.0 was free of (and hence omitted) all of: aeration tanks, settling tanks, reaction tanks, off-line buffer tanks, chemical reactions, chemical coagulants, chemical additives, biological processes, electro-coagulation, oxidizing agents, combustion, electrolysis, and sacrificial electrodes.

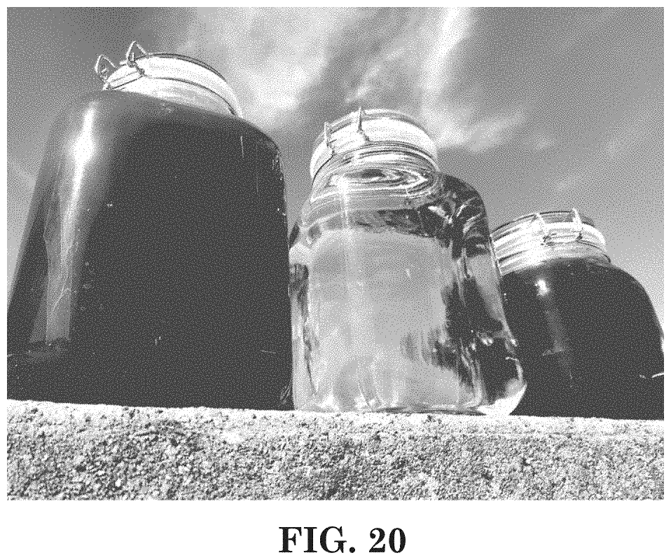

FIG. 20 is a photograph of several glass jars of material processed by the System 1.0 of FIGS. 14-19. The jar on the left contains input septage of the type that was fed into the system (see e.g. item 1002a in FIG. 10). The jar in the middle contains clear water output that was produced from such septage using the System 1.0 (see e.g. item 1002b in FIG. 10). The jar on the right contains concentrated sludge output that was produced from the input septage using the System 1.0 (see e.g. item 1002c in FIG, 10).

In connection with the above-described testing of the System 1.0, an analysis was done on numerous representative samples of the input. septage (see item 1002a FIG. 10) at different times during the tests so as to quantify the amount of contamination, or poor quality, of the input wastewater material be results are shown in Tables 5a and 5b. Turbidity of the input septage was so high as to be beyond our measurement ability, and so is not listed in these tables.

TABLE 5a
Wastewater (Input) Characteristics

| | COD | sCOD | BOD | TSS | TS |
|---|---|---|---|---|---|
| | (mg/L) | (mg/L) | (mg/L) | (mg/L) | (%) |
| Avg | 1,426 | 250 | 553 | 604 | 0.210 |
| St. Dev. | 4,327 | 145 | 218 | 352 | 0.047 |
| Median | 1,800 | 200 | 590 | 560 | 0.193 |
| Min | 97 | 90 | 250 | 145 | 0.143 |
| Max | 19,710 | 684 | 1,019 | 1,800 | 0.339 |
| N (no. of samples) | 38 | 38 | 31 | 75 | 75 |

TABLE 5b
Wastewater (Input) Characteristics (cont'ed)

| | | Total | | | | |
|---|---|---|---|---|---|---|
| | | coliform | E. coli | | | |
| | | (MPN/ | (MPN/ | TKN | NH3—N | PO4 |
| | pH | 100 mL) | 100 mL) | (mg/L) | (mg/L) | (mg/L) |
| Avg | 7 | 6,325,590 | 1,400,519 | 135 | 84 | 14 |
| St. Dev. | 0 | 4,717,911 | 1,176,257 | 29 | 20 | 3 |
| Median | 7 | 5,172,000 | 1,050,000 | 131 | 81 | 14 |
| Min | 7 | 185,000 | 272,000 | 80 | 56 | 8 |
| Max | 8 | 24,196,000 | 5,493,000 | 204 | 121 | 22 |
| N (no. of | 38 | 31 | 31 | 31 | 31 | 31 |
| samples) | | | | | | |

For the sane testing, an analysis was also done on numerous representative samples of the clear water output (see item 1002b in FIG. 10) at different times during the tests so as to quantify the quality, or cleanliness, of the output material. The results are shown in Tables 6a and 6b.

TABLE 6a
Clear water (Output) Characteristics

| | COD | sCOD | BOD | TSS | Turbidity | |
|---|---|---|---|---|---|---|
| | (mg/L) | (mg/L) | (mg/L) | (mg/L) | (NTU) | TS (%) |
| Avg | 16 | | 14 | 1 | 0.5 | 0.008 |
| St. Dev. | 16 | | 12 | — | 1.6 | 0.005 |
| Median | 10 | | 10 | 1 | 0.2 | 0.005 |
| Min | 3 | | 2 | 1 | 0.1 | 0.002 |
| Max | 66 | | 62 | 1 | 9.3 | 0.029 |
| N (no. of | 38 | | 38 | 1 | 30 | 39 |
| samples) | | | | | | |

TABLE 6b
Clear water (Output) Characteristics (cont'ed)

| | | Total | | | | |
|---|---|---|---|---|---|---|
| | | coliform | E. coli | | | |
| | | (MPN/ | (MPN/ | TKN | NH3—N | PO4 |
| | pH | 100 mL) | 100 mL) | (mg/L) | (mg/L) | (mg/L) |
| Avg | 6 | 5.9 | 1.2 | 12 | 12 | 0.2 |
| St. Dev. | 0 | 7.9 | 1.7 | 6 | 5 | 0.3 |
| Median | 7 | 3.6 | 0.5 | 11 | 11 | 0.1 |
| Min | 6 | 0.5 | 0.5 | 2 | 1 | 0.9 |
| Max | 7 | 35 | 7.4 | 39 | 31 | 1.4 |
| N (no. of | 39 | 38 | 38 | 31 | 31 | 31 |
| samples) | | | | | | |

In Table 6a, the sCOD column is blank because the measurement was unnecessary, since all COD in the clear water output was known to be in the dissolved fraction, hence, the sCOD values are identical to the COD values.

Several observations can be made by a review of Tables 5a-5b and 6a-6b:
The TSS of the input wastewater ranged from 145 to 1,800, and averaged 604 mg/L. The TSS of the output clear water was consistently 1 mg/L. The TSS of the output clear water thus ranged from 0.7% to 0.055% of that of the input wastewater.
The COD of the input wastewater ranged from 97 to 19,710, and averaged 1,426 mg/L. The COD of the output clear water ranged from 3 to 66, and averaged 16 mg/L. The average COD of the output water was thus 1.1% of that of the input wastewater.
The turbidity of the output dear water ranged from 0.1 to 9.3, and averaged 0.5 NTU.
The average sCOD of the output clear water was 6.4% of that of the input wastewater.
The average ROD of the output clear water was 2.5% of that of the input wastewater.
The average TS of the output clear water was 0.38% of that of the input wastewater.
The average total coliform of the output clear water was 0.000093% of that of the input wastewater.
The average E. coli of the output clear water was 0.000086% of that of the input wastewater.
The average TKN of the output clear water was 8.9% of that of the input wastewater.
The average NH3-N of the output clear water was 14.3% of that of the input wastewater.
The average PO4 (total phosphorus) of the output clear water was 1.4% of that of the input wastewater.

Measurements were also taken of various process parameters during the numerous test runs of the System 1.0. The resulting process measurements were generally taken at regular 30 second intervals during a given test run. The test runs themselves ranged in duration from ˜25 minutes to ˜800 minutes, with a median of 83 minutes.

Tables 7a and 7b below summarize these process measurements, and quantities derived from them:

TABLE 7a
Process Measurements for Test Runs of System 1.0

| | MF | MF | RO | Flow | Total | | |
|---|---|---|---|---|---|---|---|
| | feed | feed | feed | to | motor | MF | RO |
| | temp | press | press | MF | power | flux | dux |
| | (° F.) | (psi) | (psi) | (gpm) | (kW) | (L/m²h) | (L/m²h) |
| Avg | 66.6 | 70.1 | 148.4 | 42.5 | 47.1 | 64.3 | 12.0 |
| St. Dev. | 4.3 | 22.2 | 43.8 | 4.7 | 2.4 | 8.3 | 1.8 |
| Median | 66.5 | 72.9 | 127.9 | 41.2 | 47.8 | 61.8 | 12.5 |
| Min | 55.7 | 25.5 | 94.6 | 32.6 | 42.3 | 44.0 | 8.1 |
| Max | 72.2 | 87.6 | 275.0 | 47.3 | 53.8 | 76.4 | 16.2 |

TABLE 7b
Process Measurements for Test Runs of System 1.0 (cont'ed)

| | MF | RO | | | |
|---|---|---|---|---|---|
| | transmemb. | transmemb. | DMS re- | MF re- | RO re- |
| | press | press | covery | covery | covery |
| | (psi) | (psi) | (%) | (%) | (%) |
| Avg | 44.4 | 138.6 | 87.3 | 81.8 | 73.5 |
| St. Dev. | 9.7 | 43.3 | 5.4 | 4.7 | 4.7 |
| Median | 44.3 | 117.7 | 86.3 | 85.1 | 75.1 |
| Min | 21.9 | 90.9 | 72.4 | 70.3 | 57.5 |
| Max | 51.9 | 262.1 | 99.9 | 90.2 | 80.3 |

The values reported in Tables 7a and 7b are, unless otherwise noted, calculated not from all of the process measurements (“full set” of process measurements) but from a subset thereof (“reduced set” of process measurements) obtained by omitting datapoints for which:
flow in line L12 (see FIG. 10) was zero; or
flow in line L23 (see FIG 10) was zero; or
flow in line L5 (see FIG. 10) was nonzero.
   Of these three conditions, the last condition (nonzero flow in line L5) was the primary source of data removal. This condition is associated with a purging step of the spiral brush filter (see SBF in FIG. 10). In that regard, in the normal operation of the spiral brush filter the valve HV15 (see FIG. 10) is closed, the flow rate M line L5 is zero, the flow rate in line L6 substantially equals the flow rate in lines L3 an L2 (and L1), and debris and larger particles flowing through lines L2 and L3 accumulate in the spiral brush filter. When the accumulation in the spiral brush filter exceeds a given threshold, the timing of which depends on characteristics of the input septage 1002a (in the test runs conducted on the System 1.0, the timing averaged about once every minutes), the valve HV15 is briefly opened to purge the spiral brush filter, thus releasing the accumulated debris through line L5 and causing a drop in flow rate through line L6 and points downstream.

Still in reference to Tables 7a and 7b, the column headings have the following meanings: “MF feed temp” refers to the temperature of the MF retentate liquid in line L7, and is given in degrees F; “MF feed press” refers to the gauge pressure of the liquid in line L8, and is given in psi; “RO feed press” refers to the gauge pressure of the liquid in line L19, and is given in psi; “Flow to MF” refers to the flow rate of the liquid in line L6, and is given in gallons per minute (gpm); “Total motor power” refers to the instantaneous electrical power needed b all of the electromechanical pumps P1, P2, P3, and P4, as well as the spiral brush filter SBF, and is given in kW; “MF flux” refers to the flux of the MF unit, calculated by dividing the flow rate in line L12 by the membrane surface area of the MF unit, and is given in liters/m²h; “RO flux” refers to the flux of the RO unit, calculated by dividing the flow rate in line L19 by the membrane surface area of the RO unit, and is also given in liters/m²h; “MF transmemb. press” refers to the average of the gauge pressure in line L8 and the gauge pressure in line L9, and is given in psi; “RO transmemb. press” refers to the average of the gauge pressure in line L19 and the gauge pressure in line L20, and is given in psi; “DMS recovery” is a measure of how much of the flow in line L1 reaches line L6 (i.e. the flow in L6 divided by the flow in L1), and is given as a percentage; “MF recovery” is a measure of how much of the flow in line L6 reaches line L12 (i.e. the flow in L12 divided by the flow in L6), and is also given as a percentage; and “RO recovery” is a measure of how much of the flow in line L17 reaches line L23 (i.e. the flow in L23 divided by the flow in L17), and is also given as a percentage.

All of the columns in Tables 7a 7b use the “reduced set” of process measurements as described above except for the column “DMS recovery”, which uses the “full set” of process measurements. For each of the defined process measurements, the data points for each test run were averaged to provide a test run average. The test run averages for the various test runs were then themselves averaged together using a weighted approach according to the duration (time) of each test run, such that longer test runs were weighted more than shorter test runs. It is this weighted average that is reported in the row “Avg” in Tables 7a, 7b, for each of the columns.

Since the “DMS recovery” column uses the full set of process measurements, its average value (87.3%) is indicative of how much material is lost through line L5, when averaged over long periods of time, by the intermittent purging operation of the spiral brush filter. The other columns in the tables use the reduced set of measurements, and are thus indicative of the respective parameters during steady state operation of the System 1.0 i.e., at times when the spiral brush filter is not being purged.

Several observations can be made by a review of Tables 7a-7b:
The “How to MF”, which averages 42.5 gpm (9.65 m³/hr or 2.68 L/sec), equals the average flow rate F1 (described above, see lines L2 and L3 in FIG. 10) of the input material for the test runs of the System 1.0.
The average flow rate F2 (described above) of the clear water output material during steady state operation of the System 1.0 can be obtained by multiplying, the “Flow to MF” by the “MF recovery” and the “RO recovery”, i.e., 42.5 gpm×81.8%×73.5%=25.6 gpm (5.81 m³/hr or 1.61 L/sec). When averaged over long periods of time that take into account the purging operation of the spiral brush filter (using the average DMS recovery of 87.3%), the value of F2 drops to 22.3 gpm (5.06 m³hr or 1.41 L/sec).
Thus, for the subject test runs during steady state operation of the System 1.0, F2=81.8%×73.5%=60.1% of F1, on average. When averaged over long periods of time that take into account the purging operation of the spiral brush filter (using the average DMS recovery of 87.3%), this changes to F2=87.3%×81.8%×73.5%=52.5% of F1. The 60.1% and 52.5% values can be considered the overall recovery of the System 1.0.
The volumetric flux, i.e. F1/VS, of the System 1.0 was an average of 2.68 L/sec×(3600 sec/hr)/31.7 m³, i.e., 0.304 hr⁻¹. If straightforward engineering techniques discussed above are used to reduced the system volume VS from 31.7 to 22 m³, with no loss in system performance, the value FI/VS will increase to 0.44 hr^{-1.}
The “Total motor power”, averaging 47.1 kW, represents no less than 90% of the total power budget of the System 1.0, where the total power budget includes power used by other electrical components of the system such as the programmable electronic control system, measurement equipment, actuators, and the like. The total power budget of the System 1.0 is thus no more than 52.3 kW, which is less than 100 kW, less than 75 kW, and in a range from 25-100 kW or 25-80 kW or 50-80 kW. Given that the average input flow rate F1 was 9.65 m³/hr, this yields an Energy Consumed per Volume Processed (ECVP) value of 52.3/9.65=5.4 kW*hr/m³, which is less than 30, 20, and 10 kW*h/m³, and is in a range from 2-10 kW*hr/m³.
   Of the test runs represented in the values of Tables 7a and 7b, one test run exhibited a particularly high system recovery, and is reported separately here. The higher system recovery was achieved by using a somewhat tower flow rate F1 for the input wastewater. The duration of this test run was 66 minutes. Tables 8a and 8b below show the system parameters for this particular test run. Column headings have the same meaning as in Tables 7a and 7b, except that all of the columns in Tables 8a and 8b, including the “DMS recovery” column, use the reduced set of process measurements (for this particular run).

TABLE 8a
Process Measurements for a Specific Test Run of System 1.0

| | MF | MF | RO | Flow | Total | | |
|---|---|---|---|---|---|---|---|
| | feed | feed | feed | to | motor | MF | RO |
| | temp | press | press | MF | power | flux | flux |
| | (° F.) | (psi) | (psi) | (gpm) | (kW) | (L/m²h) | (L/m²h) |
| Avg | 68.0 | 84.3 | 122.9 | 42.0 | 46.5 | 67.9 | 13.5 |
| St. Dev. | 0.6 | 15.2 | 10.2 | 6.8 | 0.7 | 9.6 | 2.2 |
| Min | 66.5 | 10.4 | 80.6 | 14.8 | 44.3 | 27.4 | 7.4 |
| Max | 68.7 | 97.7 | 163.0 | 56.5 | 49.8 | 85.6 | 22.7 |

TABLE 8b
Process Measurements for a Specific
Test Run of System 1.0 (cont'ed)

| | MF | RO | | | |
|---|---|---|---|---|---|
| | transmemb. | transmemb. | DMS re- | MF re- | RO re- |
| | press | press | covery | covery | covery |
| | (psi) | (psi) | (%) | (%) | (%) |
| Avg | 48.9 | 110.7 | 100.0 | 87.7 | 77.9 |
| St. Dev. | 9.7 | 10.1 | | 4.5 | 1.4 |
| Min | 6.5 | 68.4 | | 75.1 | 72.9 |
| Max | 58.6 | 150.8 | | 99.9 | 82.8 |

Some observations that can be made by a review of Tables 8a-8b include:
The “Flow to MF” which averages 42.0 gpm (9.54 m³/hr or 2.65 L/sec), equals the average flow rate F1 of the input material for this test run of the System 1.0.
The average flow rate F2 of the clear water output material during steady state operation of the System 1.0 for this run can be obtained by multiplying the “Flow to mF” by the “MF recovery” and the “RO recovery”, i.e., 42.0 gpm×87.7%×77.9%=28.7 gpm (6.52 m³/hr or 1.81 L/sec).
Thus, for this particular test run during steady state operation of the System 1.0, F2=87.7%×77.9%=68.3% of F1, on average. The 68.3% value can be considered the overall recovery of the System 1.0 for this test run.
The volumetric flux, i.e. F1/VS, of the System 1.0 was an average of 2.65 L/sec×(3600 sec/hr)/31.7 m³, i.e., 0.3 hr⁻¹. If straightforward engineering techniques discussed above WV used to reduced the system volume VS from 31.7 to 22 m³, with no loss in system performance, the value FINS will increase to 0.43 hr^{-1.}
The “Total motor power”, averaging 46.5 kW represents no less than 90% of the total power budget of the System 1.0. The total power budget of the System 1.0 for this test run is thus no more than 51.7 kW, which is less than 100 kW, less than 75 kW, and in a range from 25-100 kW or 25-80 kW or 50-80 kW. Given that the average input flow rate F1 was 9.54 m³/hr, this yields an Energy Consumed per Volume Processed (ECVP) value of 51.7/9.54=5.4 kW*hr/m³, which again is less than 30, 20, and 10 kW*hr/m³, and is in a range from 2-10 kW*hr/m³.

Unless otherwise indicated, all numbers expressing quantities, measured properties, and so forth used in the specification and claims are to be understood as being modified by the term “about”. Accordingly, unless indicated to the contrary, the numerical parameters set forth in the specification and claims are approximations that can vary depending on the desired properties sought to be Obtained by those skilled in the art utilizing the teachings of the present application.

Not to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, to the extent any numerical values are set forth in specific examples described herein, they are reported as precisely as reasonably possible. Any numerical value, however, may well contain errors associated with testing or measurement limitations.

The use of relational terms such as “top”, “bottom”, “upper”, “lower”, “above”, “below”, and the like to describe various embodiments are merely used for convenience to facilitate the description of some embodiments herein. Notwithstanding the use of such terms, the present disclosure should not be interpreted as being limited to any particular orientation or relative position, but rather should be understood to encompass embodiments having any orientations and relative positions, in addition to those described above.

Various modifications and alterations of this invention will be apparent to those skilled in the art without departing from the spirit and scope of this invention, which is not limited to the illustrative embodiments set forth herein. The reader should assume that features of one disclosed embodiment can also be applied to all other disclosed embodiments unless otherwise indicated. All U.S. patents, patent application publications, and other patent and non-patent documents referred to herein are incorporated by reference, to the extent they do not contradict the foregoing disclosure.

1. A system suitable for converting wastewater to a primary output of clear water and a secondary output of concentrated sludge, the system occupying a rectilinear space of volume VS, wherein the system is configured such that, for wastewater having a total suspended solids (TSS) content of TSS I and a chemical oxygen demand (COD) of COD1:
the system receives the wastewater at a flow rate F1 and provides the primary output at least in part while receiving the wastewater;
the primary output has a flow rate F2, where F2 is at least 40% of F1;
the primary output has a TSS of less than of TSS1, a COD of less than 2% of COD1, and a turbidity of less than 1 NTU; and
F1 is at least 1 L/sec, and F1/VS is at least 0.2 hr⁻¹.

2. A system suitable for converting wastewater to a primary output of clear water and. a secondary output of concentrated sludge, the system occupying a rectilinear space of volume VS, wherein the system is configured such that, for wastewater having a total suspended solids (TSS) content of TSS1 and a chemical oxygen demand (COD) of COD1;
the system receives, the wastewater at, a flow rate F1 and provides the primary output at least in part while receiving the wastewater;
the primary output has a flow rate F2, where F2 is at least 40% of F1;
the primary output has a TSS of less than 1% of TSS1, a COD of less than 2% of COD1, and a turbidity of less than 1 NTU; and
VS is at least 5 m³, and F1/VS is at least 0.2 hr⁻¹.

3. The system of claim 1, wherein VS is at least 5 m³.

4. The system of claim 3, wherein VS is in a range from 20-30 m³.

5. The system of claim 1, wherein FINS is in a range from 0.2-0.6 hr⁻¹.

6. The system of claim 1, further comprising:
a debris management (DM) section having an input, a filtered output, and a concentrated output;
a microfiltration (MF) section having an input, a filtered output, and a concentrated output; and
a reverse osmosis (RO) section having an input, a filtered output, and a concentrated output;
wherein the input of the MF section couples to the filtered output of the DM section, and the input of the RO section couples to the filtered output of the MF section; and
wherein the primary output is the filtered output of the RO section.

7. The system of claim 6, further comprising:
an intermediate tank coupled to receive the filtered output of the MF section; and
a valve configured to selectively couple contents of the intermediate tank to the input of the MF section.

8. The system of claim 7, further comprising:
a receiving tank coupled to the DM input;
wherein the receiving tank has a capacity C1 and the intermediate tank has a capacity C2, and wherein the system includes no tank whose capacity is greater than the greater of C1 and C2.

9. The system of claim 1, wherein be system omits an aeration tank, a settling tank, a reaction tank, and an offline buffer tank.

10. The system of claim 1, wherein the system omits chemical reactions, chemical coagulants, chemical additives, biological processes, electro-coagulation, oxidizing agents, combustion, electrolysis, and sacrificial electrodes.

11. The system of claim 1, wherein the system has an Energy Consumed per Volume Processed (ECVP) value in a range from 1-20 kW*hr/m³.

12. A filtering system suitable for converting wastewater to a primary output of clear water and a secondary output of concentrated sludge, the system comprising:
a debris management (DM) section having a DM input, a DM filtered output, and a DM concentrated output;
a first filtration section having a first input, a first filtered output, and a first concentrated output; and
a second filtration section having a second input, a second filtered output, and a second concentrated output;
wherein the first input couples to the DM filtered output, and the second input couples to the first filtered output; and
wherein the primary output is the second filtered output.

13. The system of claim 12, wherein the first filtration section includes a microfiltration (MF) element, and the second filtration section includes a reverse osmosis (RO) element.

14. The system of claim 12, further comprising:
an intermediate tank coupled to receive the first filtered output; and
a valve configured to selectively couple contents of the intermediate tank to the first input.

15. The system of claim 14, further comprising:
a receiving tank coupled to the DM input;
wherein the receiving tank has a capacity C1 and the intermediate tank has a capacity C2, and wherein the system includes no tank whose capacity is greater than the greater of CI and C2.

16. The system of claim 12, wherein the system occupies a rectilinear space of volume VS, and is configured such that, for wastewater having a total suspended solids (TSS) content of TSS1 and a chemical oxygen demand (COD) of COD1:
the system receives the wastewater at a flow rate F1 and provides the primary output at least in part while receiving the wastewater;
the primary output has a flow rate F2, where F2 is at least 40% of F1;
the primary output has a TSS of less than 1% of TSS1, a COD of less than 2% of COD1, and a turbidity of less than 1 NTU; and
F1/VS is at least 0.2 hr⁻¹.

17. The system of claim 12, wherein the system omits an aeration tank, a settling tank, a reaction tank, an off-line buffer tank, chemical reactions, chemical coagulants, chemical additives, biological processes, electro-coagulation, oxidizing agents, combustion, electrolysis, and sacrificial electrodes.

18. The system of claim 16, wherein VS is at least 5 m³, and wherein F1 is at least 1 L/sec.

19. A filtering system suitable for converting wastewater to a primary output of clear water and a secondary output of concentrated sludge, the system comprising:
a debris management (DM) section having a DM input, a DM filtered output, and a DM concentrated output;
a first filtration section having a first input, a first filtered output, and a first concentrated output;
a second filtration section leaving a second input, a second filtered output, and a second concentrated output;
a tank; and
an electronic control system configured to control fluid flow through the DM module, the first filtration module, and the second filtration module;
wherein the electronic control system is configured to operate the system in a first mode wherein the DM filtered output from the DM section is received by the MF section, and the first, filtered output from the MF section is received by the tank, and contents of the tank are directed to the RO section; and
wherein the electronic control system is configured to operate the system in a second mode wherein the DM section and the RO section are fluidly isolated from the MF section, and the contents of the tank are received by the MF section, and the first filtered output from the MF section is received by the tank.

20. The system of claim 19, wherein the first filtered output received by the tank during the second mode of operation includes a doubly filtered fluid, and wherein the electronic control system is farther configured to operate the system in a third mode wherein the doubly filtered fluid is directed from the tank to the second filtration section.

21. The system of claim 19, wherein the system occupies a rectilinear space of volume VS, and is configured such that, for wastewater having a total suspended solids (TSS) content of TSS1 and a chemical oxygen demand (COD) of COD1:
the system receives the wastewater at a flow rate Fluid provides the primary output at least in part while receiving the wastewater;
the primary output has a flow rate F2, where F2 is at least 40% of F1;
the primary output has a TSS of less than 1% of TSS1, a COD of less than 2% of COD1, and a turbidity of less than 1 NTU; and
F1/VS is at least 0.2 hr⁻¹.

22. The system of claim 19, wherein the system omits an aeration tank, a settling tank, a reaction tank, an off-line butler tank, chemical reactions, chemical coagulants, chemical additives, biological processes, electro-coagulation, oxidizing agents, combustion, electrolysis, and sacrificial electrodes.

23. In a filtering system that includes a debris management (DM) section, a first filtration section, a second filtration section, and a tank, a method comprising:
operating the system in a first mode wherein a DM filtered output from the DM section is received by the first filtration section, and a first filtered output from the first filtration section is received by the tank, and contents of the tank are directed to the second filtration section; and
operating the system in a second mode wherein the DM section and the second filtration section are fluidly isolated from the first filtration section, and the contents of the tank are received by the first filtration section, and the first filtered output from the first filtration section is received by the tank.

24. The method of claim 23, wherein the first filtered output received by the tank during the second mode of operation includes a doubly filtered fluid, the method further comprising:
operating the system in a third mode wherein the doubly filtered fluid is directed from the tank to the second filtration section.
